(19) United States
(12) Patent Application Publication
(10) Pub. No.: US 2016/0057068 A1
(43) Pub. Date: Feb. 25, 2016

(54) SYSTEM AND METHOD FOR TRANSMITTING DATA EMBEDDED INTO CONTROL INFORMATION

(71) Applicant: FUJITSU LIMITED, Kawasaki-Shi (JP)

(72) Inventors: Yuki ARAKAWA, Numazu (JP); Takahiro KAWASHIMA, Numazu (JP)

(73) Assignee: Fujitsu Limited, Kawasaki (JP)

(21) Appl. No.: 14/823,403

(22) Filed: Aug. 11, 2015

(30) Foreign Application Priority Data
Aug. 19, 2014 (JP) 2014-166741

(51) Int. Cl. H04L 12/863; H04L 12/721

(52) U.S. Cl. CPC H04L 47/50; H04L 45/72

(57) ABSTRACT

An apparatus executes a transmission-side process on target data to be transmitted to another apparatus through a communication path. The transmission-side process generates transmission data including payload information and control information, where the control information includes the target data and address information indicating a destination address of the target data. The another apparatus includes a queue area configured to store pieces of information as queueing data so as to prevent a piece of information from being overwritten by another piece of information. The apparatus controls transmission of the transmission data to the another apparatus by embedding the target data into the control information included in the transmission data. The another apparatus stores the control information included in the received transmission data into the queue area as queuing data, and extracts the embedded target data from the control information stored in the queue area.

### CROSS-REFERENCE TO RELATED APPLICATION

This application is based upon and claims the benefit of priority of the prior Japanese Patent Application No. 2014-166741, filed on Aug. 19, 2014, the entire contents of which are incorporated herein by reference.

### FIELD

The embodiment discussed herein is related to system and method for transmitting data embedded into control information.

### BACKGROUND

When using a so-called supercomputer, large-scaled scientific computing (high performance computing (HPC)), for example, is mainly intended in many cases. Therefore, in the supercomputer, the processing performance of an entire system is one of the most important items.

The supercomputer includes a plurality of computing nodes serving as information processing apparatuses each include a processor element (PE) and a communication module, a network that interconnects the plurality of computing nodes, and the like in the system. Each of the PEs includes a central processing unit (CPU) as an operation processing device and a memory as a main storage device.

A user executes a single program by activating respective processes on the plurality of PEs of the system. When such a program is executed, there is a case in which inter-process data communication occurs. In the inter-process data communication, for example, an application programming interface (API) called a message passing interface (MPI) is used.

In a recent supercomputer, there is a tendency that the number of included PEs increases. In addition, the use of a multi-core CPU is progressed in the PE, and thus a tendency is gradually changing such that a plurality of processes are set up on a single PE and then processing is performed. Therefore, the number of processes, which are used due to the execution of the program in the supercomputer, or the number of inter-process communications, which occur due to the execution of the program, increases.

In a program, in which inter-process data communications between a plurality of processes occur, a communication process between the computing nodes is more important than ever in the processing of the entire program. The MPI includes, for example, an API in which data is transferred to a specific process (group) by another process (group), and an API in which the data of entire inter-process are transposed and exchanged. When the process of such an API is executed, communication increases according to the increase in the number of processes, and thus the influence of the inter-process communication increases with regard to the process performance of the entire program.

In contrast, as a technique related to data communication, there is provided a technique in which, when a data transfer request is received, a transmission unit prepares a remote direct memory access (RDMA) packet from transmission target data and speculatively transmits the RDMA packet without inquiring of a transfer destination about whether or not reception of data is permitted. When a reception area is not available for data reception, the transmission unit retransmits the RDMA packet when a retransmission request is received from the transfer destination. A reception unit destructs a reception packet when the packet is received and it is determined that transfer is not permitted with reference to transfer area management information, and thereafter when it is determined that transfer is permitted, the reception unit transmits the retransmission request so as to transfer the packet.

Japanese Laid-open Patent Publications Nos. 2007-257479 and 2011-234145 have been known as examples of the related art.

Yuichiro Ajima, Yuzo Takagi, Tomohiro Inoue, Shinya Hiramoto, Toshiyuki Shimizu: “The Tofu Interconnect”, The 19th Annual Symposium on High-Performance Interconnects, p. 87-94(2011) and Yuichiro Ajima, Tomohiro Inoue, Shinya Hiramoto, Toshiyuki Shimizu, Yuzo Takagi: “The Tofu Interconnect”, IEEE Micro, Vol. 32, No. 1, p. 21-31(2012) have been known as examples of the related art.

### SUMMARY

According to an aspect of the invention, a system includes a transmission-side apparatus and a reception-side apparatus. The transmission-side apparatus includes a first processor configured to execute a transmission-side process on target data to be transmitted to the reception-side apparatus through a communication path, where the transmission-side process generates transmission data including payload information and control information, and the control information includes the target data and address information indicating a destination address of the target data. The transmission-side apparatus further includes a first memory including a transmission-side storage area for holding the target data, and a first communication module configured to transmit the transmission data through the communication path. The reception-side apparatus is coupled to the transmission-side apparatus through the communication path, and includes a second memory including a queue area configured to store pieces of information as queueing data so as to prevent a piece of information from being overwritten by another piece of information, a second communication module configured to receive the transmission data transmitted from the transmission-side apparatus through the communication path, and a second processor configured to execute a reception-side process. The transmission-side process controls transmission of the transmission data to the reception-side apparatus through the communication path by embedding the target data into the control information included in the transmission data, and the reception-side apparatus stores the control information included in the received transmission data into the queue area as queuing data, and extracts the embedded target data from the control information stored in the queue area.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIGS. 1A and 1B are diagrams illustrating an example of difference between an MPI communication function and an RDMA communication function;

FIG. 2 is a diagram illustrating an example of an Eager protocol;

FIG. 3 is a diagram illustrating an example of a Rendezvous-RDMA read protocol;

FIG. 4 is a diagram illustrating an example of a Rendezvous-RDMA write protocol;

FIG. 5 is a diagram illustrating an example of a procedure in which data of an MPI area of a transmission node is transmitted to an MPI area of a reception node;

FIG. 6 is a diagram illustrating an example of a first method;

FIG. 7 is a diagram illustrating an example of a retransfer state when data is overwritten in a 2-1 method;

FIG. 8 is a diagram illustrating an example of control which is performed to prevent data from being overwritten in a 2-2 method;

FIG. 9 is a diagram illustrating an example of control which is performed to prevent data from being overwritten in a 2-3 method;

FIG. 10 is a diagram illustrating an example of an operational sequence of a communication method, according to an embodiment;

FIG. 11 is a diagram illustrating an example of configuration of an information processing system, according to an embodiment;

FIG. 12 is a diagram illustrating an example of configuration of a communication node, according to an embodiment;

FIGS. 13A and 13B are diagrams each illustrating an example of embedment of transmission target data into a descriptor by a setting unit, according to an embodiment;

FIG. 14 is a diagram illustrating an example of a state in which transmission target data is transferred after being divided and embedded into a plurality of descriptors, according to an embodiment;

FIG. 15 is a diagram illustrating an example of a data structure of a descriptor, according to an embodiment;

FIG. 16 is a diagram illustrating an example of the embedded areas of a descriptor, according to an embodiment;

FIG. 17 is a diagram illustrating an example of a state in which two transmission processes simultaneously transmit data to a single reception process in a dummy communication, according to an embodiment;

FIGS. 18A and 18B are diagrams illustrating an example of comparing a first method in a basic communication with a method of securing a buffer in the dummy communication, according to an embodiment;

FIG. 19 is a diagram illustrating an example of an operational flowchart for a process performed by a transmission node in dummy communication, according to an embodiment;

FIG. 20 is a diagram illustrating an example of an operational flowchart for a process of a transmission process A, according to an embodiment;

FIG. 21 is a diagram illustrating an example of an operational flowchart for a process of a transmission process B, according to an embodiment;

FIG. 22 is a diagram illustrating an example of an operational flowchart for a process in dummy communication performed by a reception node, according to an embodiment;

FIG. 23 is a diagram illustrating an example of an operational flowchart for a reception process A, according to an embodiment;

FIG. 24 is a diagram illustrating an example of an operational flowchart for a reception process B, according to an embodiment;

FIG. 25 is a diagram illustrating an example of an operational flowchart for a reception process C, according to an embodiment;

FIG. 26 is a diagram illustrating an example of an operational flowchart for a data reception process performed by a communication module, according to an embodiment; and

FIG. 27 is a diagram illustrating an example of a hardware configuration of an information processing system, according to an embodiment.

### DESCRIPTION OF EMBODIMENT

In the above-described technique, there is a case in which, when a plurality of inter-process communications simultaneously occurs, reception data, which is stored in a reception-side buffer, is overwritten by reception data in another inter-process communication before the reception data is used by a reception process. In this case, the data, on which the other reception data has been overwritten, disappears from the reception side buffer, and thus, the control communication occurs in order to acquire the lost data again. When there are a large number of processes to be communicated or when there is a large amount of processing in each process, the influence of delay increases due to the occurrence of the control communication.

For example, an MPI is used for an inter-process data communication in a supercomputer as an information processing system. A communication is performed by selecting, for example, one of three protocols when an MPI library is implemented. The three protocols include an Eager protocol, a Rendezvous-RDMA read protocol, and a Rendezvous-RDMA write protocol.

In the description below, there is a case in which target data, which is transferred to a reception process by a transmission process in the inter-process communication, is described as transmission target data.

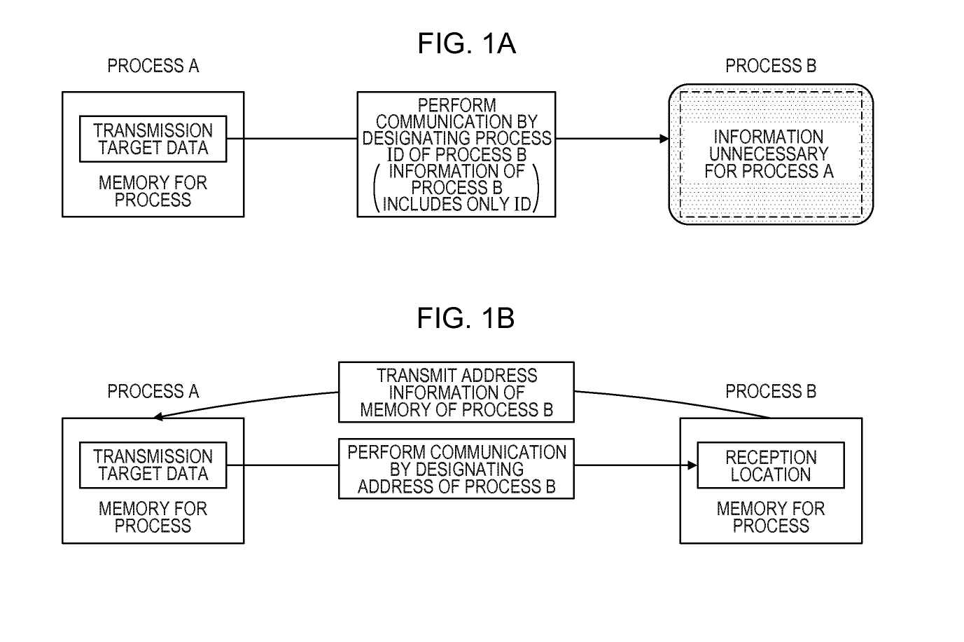

First, the difference between an MPI communication function and an RDMA communication function will be described. FIGS. 1A and 1B are diagrams illustrating the difference between the MPI communication function and the RDMA communication function. FIG. 1A is a diagram illustrating a communication using the MPI communication function. FIG. 1B is a diagram illustrating a communication using the RDMA communication function.

As illustrated in FIG. 1A, in a case of the communication using the MPI communication function, a process A, which transmits data, is able to transmit data by using information on the process A and information on the process ID of a process B which is a communication counter party. More specifically, the process A transmits data to the process B by designating the process ID of the process B which is a communication counter party destination. As above, in a case of the communication using the MPI communication function, the process A is able to perform a data communication without holding information relevant to the process B other than the process ID. The process ID of the communication counter party may be obtained using another MPI function.

In contrast, in a case of the communication using the RDMA communication function, the process A transmits data by using information on communication control with regard to the process B in addition to the process ID of the process B, as illustrated in FIG. 1B. That is, when the process A does not hold the information on the communication control with regard to the process B, it is not possible to transmit the data to the process B. The information on the communication control includes, for example, information of the address of a memory, in which the transmission target data is stored, in a reception node as a reception-side information processing apparatus. The process A acquires information on the communication control with regard to the process B from the process B in advance of the data communication. Further, based on the acquired information, the process A transmits data to the process B by designating the address or the like of the memory of the reception node. As above, in the communication using the RDMA communication function, control communication occurs in order to exchange information on the communication control of the communication counter party.

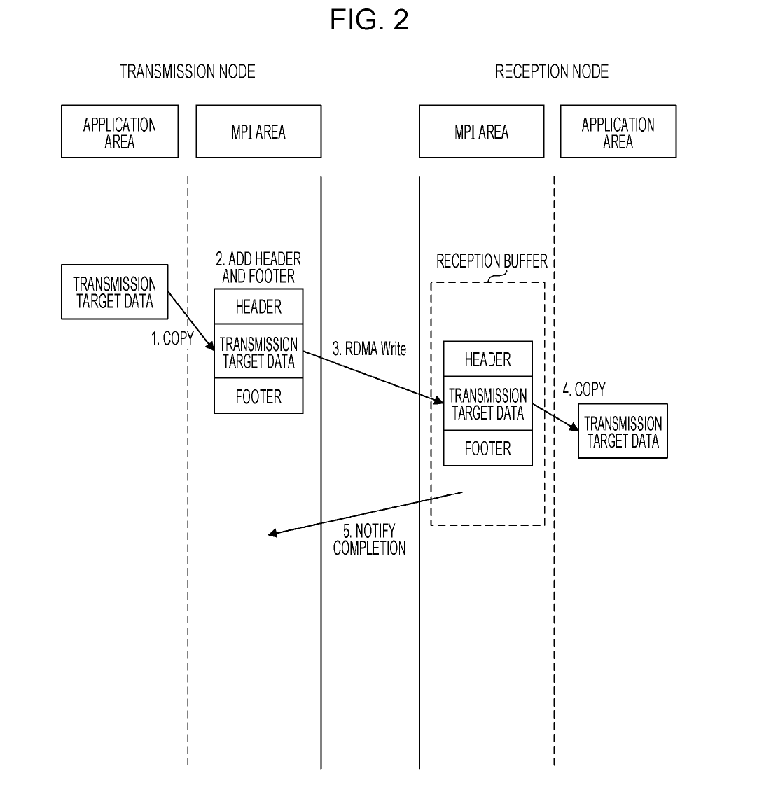

Subsequently, the three protocols used in the embodiment will be described with reference to FIGS. 2 to 4. First, the Eager protocol will be described.

In the communication using the Eager protocol, the control communication is not performed in advance of communication of transmission target data. Instead, a reception buffer is secured using the MPI library in the reception node. When the transmission target data is received by the reception node, the transmission target data is stored in the reception buffer. Thereafter, the transmission target data, which is stored in the reception buffer, is copied into a memory area (user area) which is used by an application. In the description below, there are cases in which a memory area used by the MPI library is described as an MPI area, and a memory area used by the application is described as an application area. The reception buffer is secured in the MPI area. Also, the application area may be a specific storage area.

FIG. 2 is a diagram illustrating the Eager protocol. As illustrated in FIG. 2, first, the transmission process copies the transmission target data from the application area onto the MPI area. Subsequently, the transmission process adds a header and a footer, in which tag information or the like is stored, to the copied transmission target data, and transmits the transmission target data to the reception process. When the reception process receives the data, the reception process stores the received data in the reception buffer. Subsequently, the reception process takes the header and the footer off from the transmission target data, and copies the transmission target data onto the memory area to be used by the application. Further, the reception process provides a notification that the reception of the transmission target data is completed, to the transmission process.

The communication using the Eager protocol is suitable for transferring a relatively small amount of data. More specifically, data, which is suitable for the communication using the Eager protocol, includes data having a size which fits in the reception buffer corresponding to the transmission process, and includes, for example, data whose size is up to 1 megabyte. Also, it is assumed that the transmission process in the communication using the Eager protocol knows the address of the reception node in advance.

Subsequently, the Rendezvous-RDMA read protocol will be described. In the communication using the Rendezvous-RDMA read protocol, the control communication is performed in order to exchange information on the communication control of the communication counter party in advance of communication of the transmission target data. More specifically, the reception process acquires the information on the communication control of the transmission process through the control communication. Further, the reception process acquires the transmission target data from a transmission-side application area by using the acquired information, and directly stores the transmission target data in the application area of the reception node.

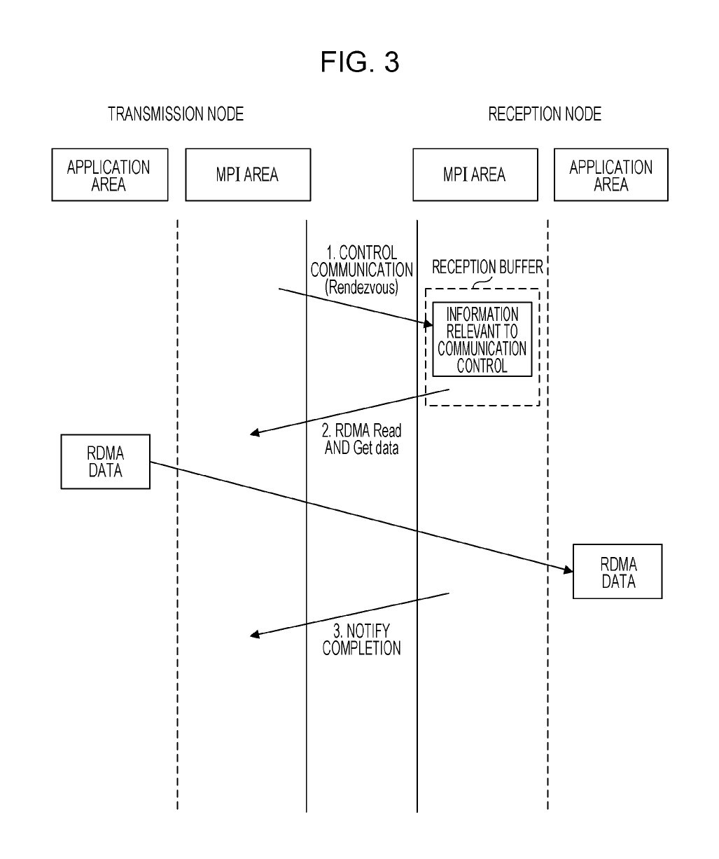

FIG. 3 is a diagram illustrating the Rendezvous-RDMA read protocol. As illustrated in FIG. 3, first, the transmission process transmits information on the communication control to the reception process via the control communication. When the information on the communication control is received, the reception process stores the information on the communication control in the reception buffer. Subsequently, the reception process issues a transmission target data acquisition request (RDMA Read) by designating, for example, the address of the transmission node as a transmission-side information processing apparatus, in which the acquired target data is stored, or the address of the reception node in which the acquired data is stored, based on the information on the communication control. When the transmission target data acquisition request is received, the transmission process transmits the transmission target data to the application area of the reception node. When the transmission target data is received, the reception process transmits a notification that the communication is completed to the transmission process.

The communication using the Rendezvous-RDMA read protocol is suitable for transferring large capacity data compared to the communication using the Eager protocol. More specifically, the data, which is suitable for the communication using the Rendezvous-RDMA read protocol, includes data whose size is larger than the size of the reception buffer corresponding to the transmission process, for example, data whose size is larger than 1 megabyte.

Subsequently, the Rendezvous-RDMA write protocol will be described. In the communication using the Rendezvous-RDMA write protocol, the control communication is performed in order to exchange information on the communication control of the communication counter party in advance of the transmission target data communication, in a manner similar to the communication using the Rendezvous-RDMA read protocol. More specifically, the transmission process transmits information on the communication control of the transmission process to the reception process via the control communication, and acquires the information on the communication control of the reception process as a response. Further, the transmission process transmits the transmission target data from the transmission-side application area, and directly stores the transmission target data into the application area of the reception node (RDMA Write).

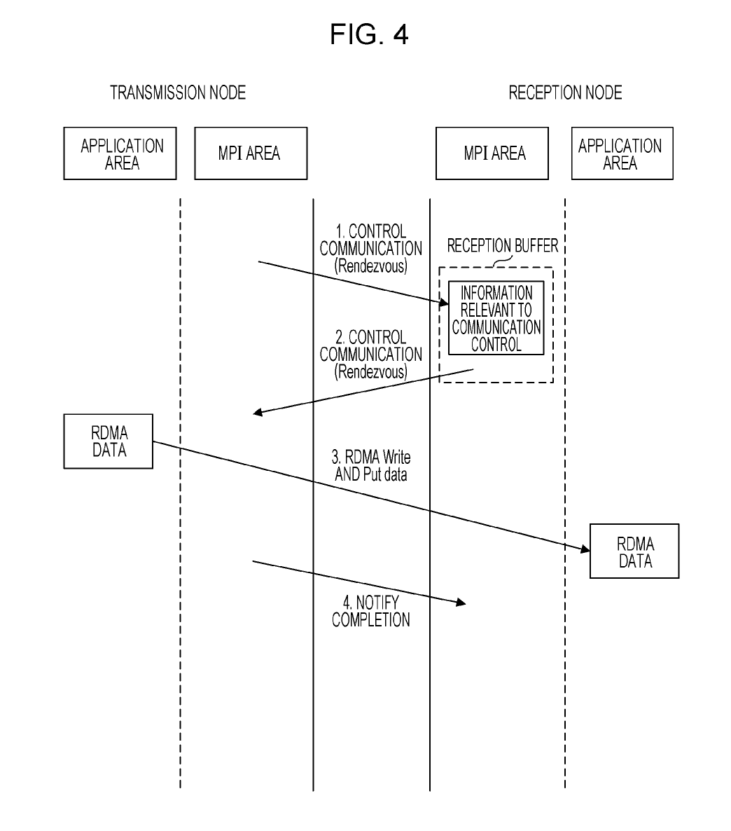

As illustrated in FIG. 4, first, the transmission process transmits information on the communication control of the transmission node, to the reception process through the control communication. When the information on the communication control is received, the reception process stores the information on the communication control in the reception buffer. Subsequently, the reception process transmits the information on the communication control of the reception node to the transmission process. Subsequently, the transmission process transmits the transmission target data by designating the address of the application area of the reception node, which is the storage destination of the transmission target data, based on the information on the communication control of the reception process. This allows the transmission process to write the transmission target data into the designated application area. Further, the transmission process transmits the notification that the communication is completed, to the reception process.

Similarly to the communication using the Rendezvous-RDMA read protocol, the communication using the Rendezvous-RDMA write protocol is suitable for transferring a large amount of data compared to the communication using the Eager protocol.

In the communications using the three protocols, there is a case in which data is simultaneously transmitted from different transmission processes. Therefore, there is a case in which reception buffers are secured for the respective transmission processes. In this case, when a mass communication occurs, reception-side memory usage increases.

Also, a transmission-side MPI area is an area which may be used when another transmission process transmits another data. Therefore, even when a plurality of transmission processes cause simultaneous communications, a case in which the transmission-side MPI area becomes insufficient occurs less-frequently compared to a reception-side MPI area.

Subsequently, a procedure in which the data of the MPI area of a transmission node is transmitted to the MPI area of the reception node will be described. In the description below, there is a case in which data that is transferred from the MPI area of the transmission node to the MPI area of the reception node is referred to as communication data. In the case of communication using the Eager protocol, communication data is transmission target data. In the cases of communications using the Rendezvous-RDMA read protocol and the Rendezvous-RDMA write protocol, communication data is information on the communication control.

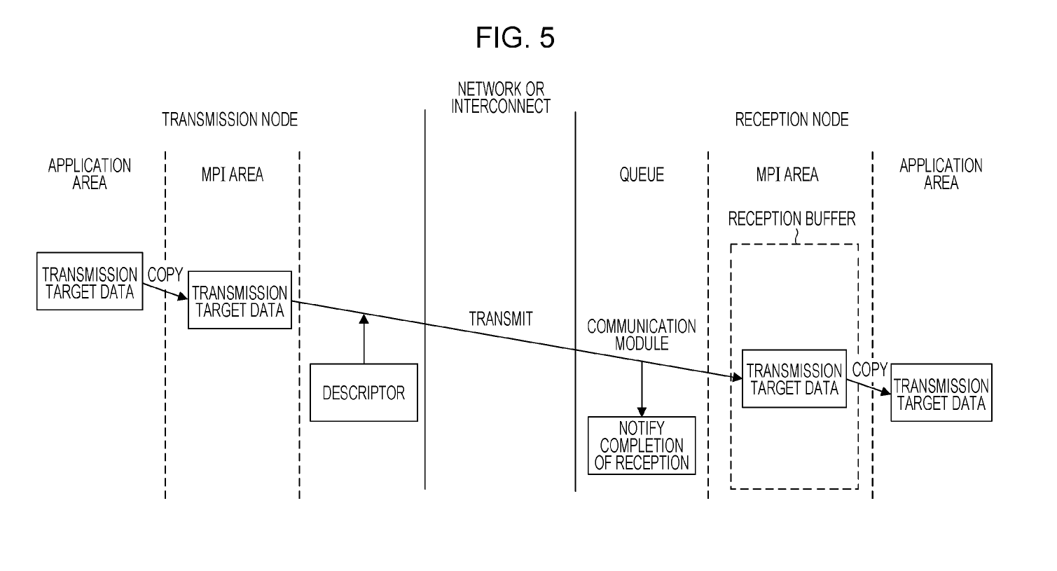

FIG. 5 is a diagram illustrating a procedure in which the data of the MPI area of the transmission node is transmitted to the MPI area of the reception node.

In FIG. 5, the MPI library of the transmission node (hereinafter, referred to as a transmission MPI library) first copies the communication data from the application area onto the MPI area. Further, the transmission MPI library starts a transmission process of the communication data of the MPI area. Before the data is transmitted, the transmission MPI library generates control information in order to control the communication of the communication data (hereinafter, referred to as a descriptor). The transmission MPI library transmits the communication data to the reception node, together with the descriptor (the control information), through a network or an interconnect as a communication path.

Upon receiving the communication data and the descriptor from the transmission node, the reception node stores the communication data in a buffer secured in the MPI area. When the communication data is completely stored in the buffer, the communication module of the reception node generates a reception completion notification including information of a part of the descriptor, and stores the generated reception completion notification in a queue. The queue is implemented by the communication module by using the memory of the reception node. Here, the communication module may be controlled by the hardware of the reception node or may be implemented by the function of the MPI library.

Subsequently, the MPI library of the reception node (hereinafter, referred to as a reception MPI library) refers to the reception completion notification which is stored in the queue and accesses the communication data in the buffer, based on the referred reception completion notification. Here, the reception MPI library recognizes whether or not the reception completion notification is stored in the queue by performing polling on the queue.

Further, the MPI library copies the communication data from the buffer onto the application area or the MPI area, according to the communication protocol. That is, when the communication protocol is the Eager protocol, the MPI library copies the communication data onto the application area so that the application or the like accesses the copied data in the application area. When the communication protocol is the Rendezvous-RDMA read or the Rendezvous-RDMA write, the MPI library copies the communication data onto another area in the MPI area. When the communication protocol is the Rendezvous-RDMA read or the Rendezvous-RDMA write, the communication data, which is copied onto the MPI area, is information on the communication control of the transmission node, and RDMA-Read or RDMA-Write is performed based on the information. In the description below, there is a case in which it is described that the communication data is being used for the communication during a time period from when the communication data is stored in the buffer to when the communication data is copied onto another area in the reception node.

The descriptor is communication control information which is used to control the inter-process communication of relevant communication data. The descriptor is used by the communication module which performs the communication process. More specifically, although being described later, the descriptor includes, for example, information of a communication method, the location of the data of the communication counter party on the memory, the size of the communication data, and the location of the communication counter party. For example, a descriptor, which is generated when a process X transmits the communication data to a process Y, may include information below. That is, the information, which is included in the descriptor, includes information indicating that RDMA-Write is performed, information indicating that data having a size of “L” bytes is written into the memory of the process Y from an address “AAAA”, and information indicating that the communication data of the process X exists at an address “BBBB”.

The transmission MPI library may be performed by the transmission process, and the reception MPI library may be performed by the reception process. In addition, a process of the communication module, which have received a notification that data is transmitted from the transmission process, or specific software (program), may generate the descriptor.

In the communication using the MPI as described above, an area, which is used to temporally store the communication data, is used in the reception node. For example, a process of performing a communication acquires a buffer in the MPI area of each node, and uses the buffer for the communication. In contrast, for example, in the communication using transmission control protocol/internet protocol (TCP/IP) or the like, the communication is possible without using the buffer on the process.

A method of securing a buffer in the inter-process communication includes two methods, that is, a method of securing buffers for each inter-process communication, and a method of securing a fixed-length reception buffer which is shared and used by all the processes.

In the method (first method) of securing a buffer for each inter-process communication, the reception process secures buffers in different areas of the MPI areas for each inter-process communication. That is, the reception process secures the buffers such that the areas of the buffers, which are secured for the respective inter-process communications, do not overlap with each other.

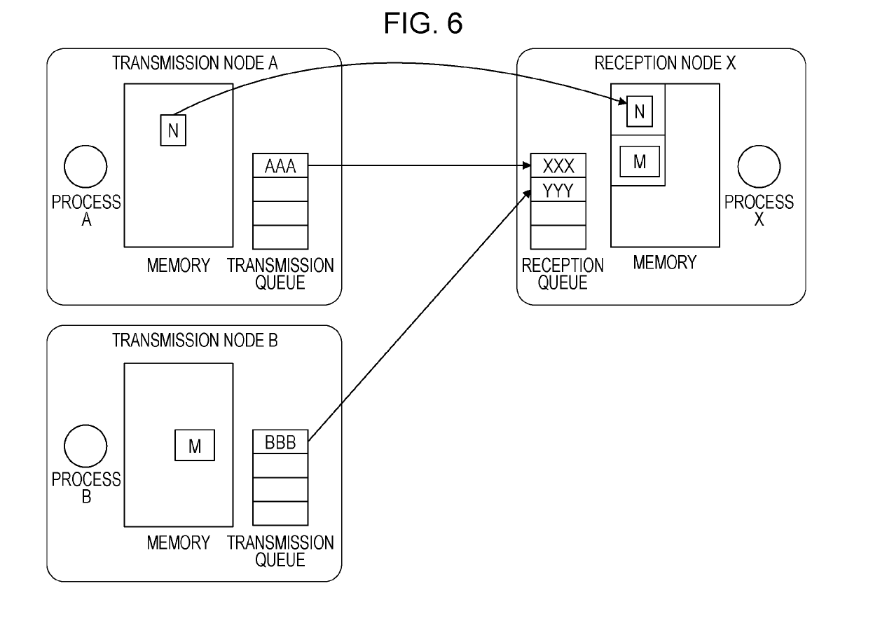

FIG. 6 is a diagram illustrating the first method. In FIG. 6, the process A transmits communication data N to the process X. A descriptor N′ corresponding to the communication data N, which is transmitted by the process A, includes information which indicates that the communication data N is stored in an area having a size of n bytes from a head address “AAA” in the memory of the transmission node A. In addition, the descriptor N′ includes information indicating that a process corresponding to the transmission destination of the communication data N is the process X. In addition, the descriptor N′ includes information indicating that the area of the transfer destination of the communication data N is an area, in which an address “XXX” is the head address, of the reception node X.

In addition, the process B transmits communication data M to the process X. A descriptor M′ corresponding to the communication data M, which is transmitted by the process B, includes information indicating that the communication data M is stored in an area having a size of m bytes from a head address “BBB” in the memory of the transmission node B. In addition, the descriptor M′ includes information indicating that a process corresponding to the transmission destination of the communication data M is the process X. In addition, the descriptor M′ includes information indicating that the area of the transfer destination of the communication data M is an area, in which an address “YYY” is the head address, of the reception node X.

In the reception node X, the buffers are allocated for the respective process A and process B which are the processes of the communication counter parties of the process X. Pieces of communication data, which are received from the process A and the process B, are stored in the buffers which are allocated for the respective processes. When the pieces of communication data are stored in the buffers, the reception completion notification is written in a queue for reception. The process X recognizes the reception completion notification in the queue, and accesses the communication data at the address of the memory, which is written in the reception completion notification. Further, the process X copies the communication data onto another area according to the communication protocol.

For example, the process X specifies the top address “XXX” of an area, in which the communication data N is stored, and the data size n with reference to the reception completion notification of the communication data N. Further, the process X accesses data which is stored in an area starting from the address “XXX” and having a size of n, and copies the data onto another area.

The reception buffer may be allocated for each inter-process communication.

Although being described later, when a buffer is shared and used by all the processes, there may be a case in which data being used in a communication is overwritten by another piece of data when a plurality of inter-process communications simultaneously occurs. In contrast, in the first method, it is possible to prevent the data being used in the communication from being overwritten even when the plurality of inter-process communications simultaneously occurs within a single node. This is because buffer areas, which are secured in the respective inter-process communications, are different from each other. Therefore, a separate inter-process communication does not occur in order to implement control such that overwriting of data is avoided. Accordingly, even when the plurality of inter-process communications simultaneously occurs, it is possible to suppress the deterioration of the processing performance due to the control for preventing data from being overwritten.

However, in the first method, buffers are secured for the respective inter-process communications. Therefore, when a mass inter-process communication occurs, a memory capacity which is used by the MPI library becomes enormous. When a MPI area increases, an application area, which may be used in the memory of each node, is decreased as much as the increased MPI area. A physical memory, which is mounted on each node, is limited. In particular, similarly to the field of HPC, when a mass inter-process communication occurs, there is a problem of the deterioration in the process performance of the application due to the depletion of the memory or the lack of the memory.

When the transmission node is connected to the reception node through an interconnect in which a temporary area capable of being used in a communication does not exist, influence of the problem arising from the memory usage of the reception node increases. Such an interconnect includes, for example, Torus fusion (Tofu) interconnect or the like.

The method (second method) of securing a reception buffer which is common to all the processes is a method of setting a buffer used in the reception node to a common buffer in all the inter-process communications. The common buffer is secured so as not to exceed the capacity of a memory capable of being secured as the MPI area in each node. Therefore, when the mass inter-process communication occurs, it is possible to suppress the memory capacity which is used by the MPI library to a prescribed range. However, in the second method, in order to prevent in-use data from being overwritten, an inter-process communication, which is separated from the communication performed to transmit the communication data, occurs. The second method is further partitioned into three methods (2-1 method to 2-3 method) based on a method of controlling the buffer.

The 2-1 method is a method of not controlling the use of the buffer of each process. In the 2-1 method, no control is performed on the use of the buffer. Therefore, when a plurality of inter-process communication occurs in a single node, there is a possibility that data which is being used in the communication is overwritten. For example, there is a case in which two different processes simultaneously transmit data to the same process so that data is stored in the same address of the reception buffer. When data which is being used in the communication is overwritten, the received data disappears from the reception node, and thus it is difficult for the application or the like to access the received data. Therefore, when data is overwritten, the reception process controls the communication so that the overwritten data is retransferred.

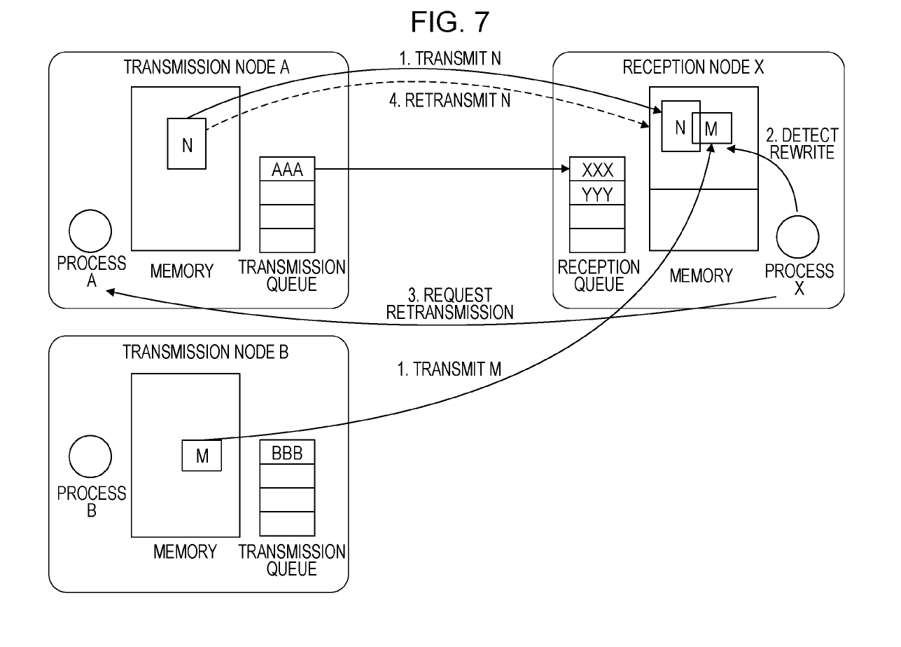

FIG. 7 is a diagram illustrating a retransfer state when data is overwritten in the 2-1 method. In FIG. 7, the process A and the process B simultaneously transmit communication data N and communication data M to the process X, respectively. Here, one of the process A and the process B neither knows that the other one of the processes A and B transmits the data to the process X, nor knows the area of the buffer of the process X to which the data are transmitted. When the area of the buffer, in which the communication data N and the communication data M are stored, overlaps in the reception node X, one of data N and M is overwritten by the other one of data N and M. When such overwriting occurs, the process X transmits a communication data retransmission request to the transmission process (process A in FIG. 7) of the overwritten data. When the retransmission request is received, the process A transmits the communication data N to the process X again.

As described above, in the 2-1 method, a communication for retransfer occurs when data is overwritten. In addition, in order to control the retransfer, a process of recording the order of communications during execution is generated like a checkpoint/restart. Therefore, a time for backup or recovery is required.

The 2-2 method is a method of performing control for dividing a reception buffer, which is common to all the processes, by the number of processes. In the 2-2 method, a transmittable data size is restricted for each process. The data size is in inverse proportion to the number of processes. Therefore, when data, which has a size greater than the transmittable data size, is transmitted, the transmission process transmits the communication data by dividing the communication data into plural pieces of communication data. It may be considered that the plural pieces of data are continuously transmitted. In this case, there is a high probability that a case occurs in which, after a piece of divided data is received, a subsequent piece of divided data is received in the reception node before the previously received piece of divided data is completely processed. According to the 2-2 method, when data is newly received before the previously received data is completely processed, the reception process overwrites data, which is received thereafter, on the unprocessed data stored in the buffer.

In order to prevent the data from being overwritten, control is performed such that the reception process transmits a notification (transmission permission notification) that transmission of data is permissible, to the transmission process, and the transmission process transmits data after receiving the transmission permission notification.

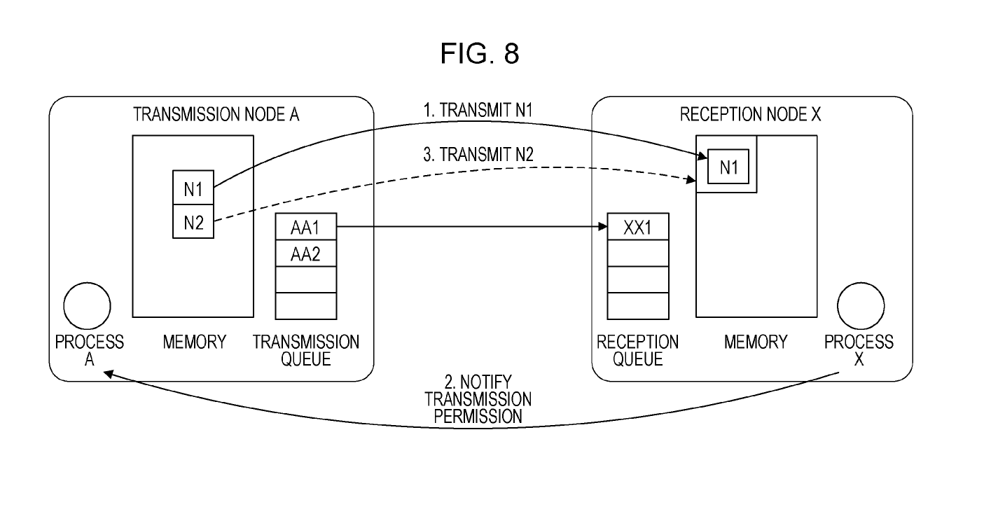

FIG. 8 is a diagram illustrating a control which is performed to prevent the data from being overwritten in a 2-2 method. In FIG. 8, the process A continuously transmits plural pieces of communication data N1 and N2, which are acquired by dividing prescribed data, to the process X. Here, the process X stores the communication data N1 in the memory, and then receives the communication data N2 before the communication data N1 is copied onto another area. In this case, the reception process overwrites the communication data N2 on the communication data N1 which is being used.

Here, when the communication data N1 is received, the process X recognizes that the communication data N1 is copied onto another area, and then transmits the transmission permission notification to the process A. The process A transmits the communication data N2 to the process X after recognizing that the transmission permission notification is received. Therefore, it is possible to prevent the data, which is being used in the communication, from being overwritten.

However, in the 2-2 method, a communication in which the transmission permission notification is transmitted, occurs in order to avoid the overwriting, and the transmission process transmits subsequent communication data after waiting for the reception of the transmission permission notification, thereby causing deterioration of latency.

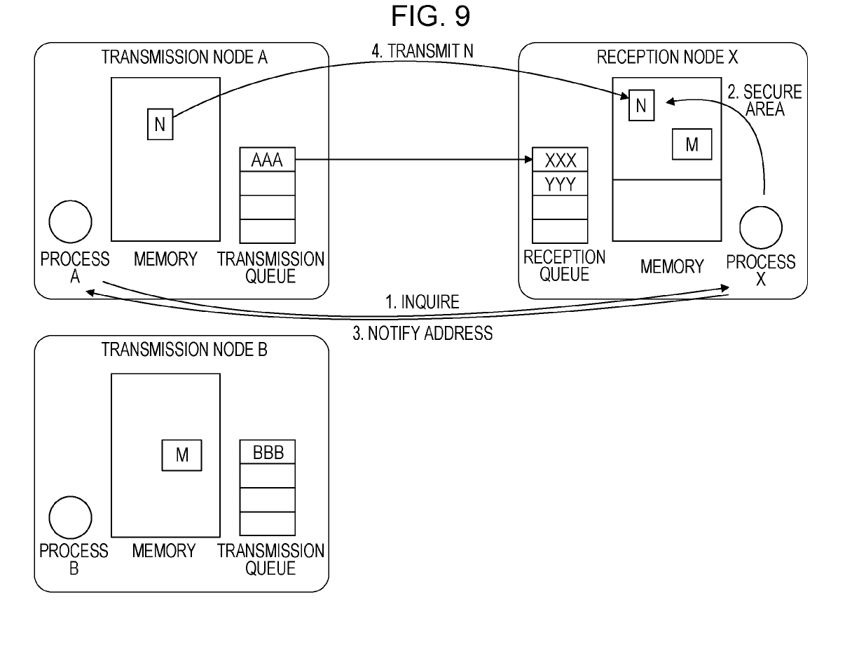

The 2-3 method is a method of performing control such that the reception process dynamically secures a buffer in the reception buffer which is common to all the processes. FIG. 9 is a diagram illustrating control which is performed to prevent the data from being overwritten in a 2-3 method.

In the 2-3 method, first, the transmission process A demands that the reception process X secure an area of the buffer. The process X secures the area of the buffer according to the demand. Here, the process X performs exclusive control on the secured area of the buffer. Also, when it is difficult to secure an area of the buffer by reason of the lack of the memory, waiting occurs. Further, the process X notifies the process A of the address of the secured buffer. The process A waits until the address of the buffer is notified. When the notification is received, the process A transmits the data by designating the address of the buffer indicated by the notification.

As described above, in the 2-3 method, a communication occurs in order to secure the area of the buffer. Increase in the number of communications causes the deterioration of latency, and increases a time taken for the exclusive control performed on the reception buffer.

Subsequently, a state in which the transmission target data is transferred from the transmission process to the reception process in an embodiment will be described.

In the embodiment, the transmission process sets communication data as payload information, for example, as dummy data of null data, and embeds the transmission target data into descriptors corresponding to respective pieces of dummy data. Further, the transmission process transmits the dummy data as the communication data and the descriptor to the reception node. The reception process acquires the transmission target data by extracting the transmission target data from the descriptors into which the transmission data is embedded. Here, the dummy data may be null data or may be actual data which includes some data.

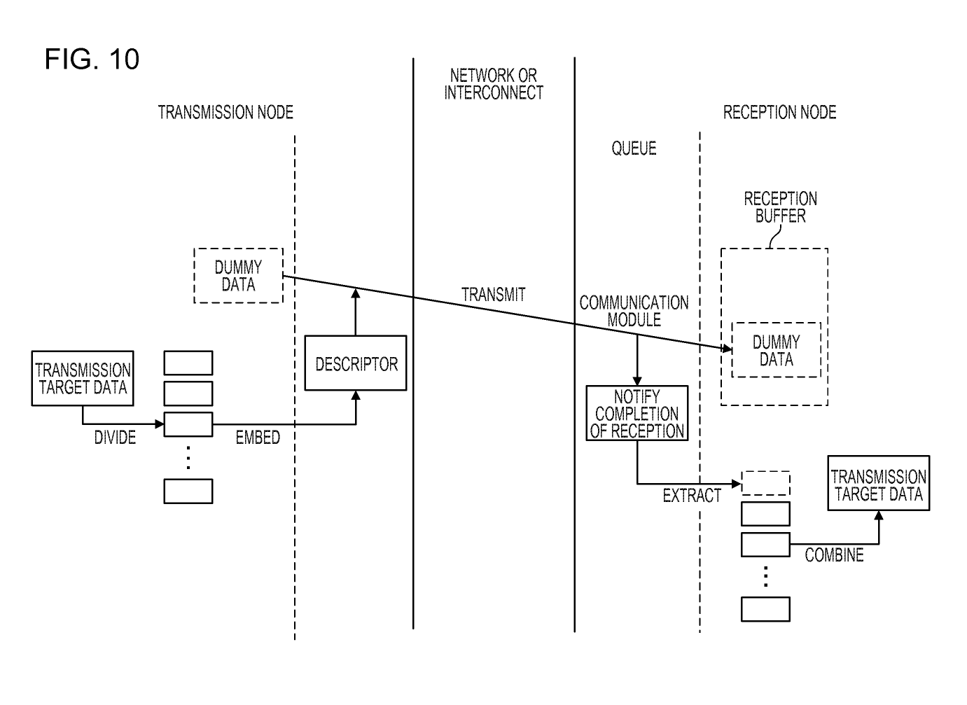

FIG. 10 is a diagram illustrating an example of an operational flowchart for a communication method, according to an embodiment. In FIG. 10, the transmission process first generates pieces of dummy data and descriptors corresponding to the respective pieces of dummy data. Subsequently, transmission process generates data segments by dividing the transmission target data, and embeds each of the data segments into a specific area of the descriptor. Further, the transmission process transmits the dummy data and the descriptor corresponding to the dummy data to the reception node through a network or interconnect.

When the reception node receives dummy data and the descriptor corresponding to the dummy data, the reception node first stores the dummy data in a reception buffer. When the dummy data is completely stored in the reception buffer, the reception process generates a reception completion notification based on the descriptor and stores the reception completion notification in a queue. Subsequently, the reception process extracts a data segment from the reception completion notification which is stored in the queue. Further, the reception process reconstructs communication data by connecting the extracted data segments thereto. Thereafter, the reception process copies the reconstructed communication data onto the application area or the MPI area according to the communication protocol.

In the description below, the communication data, which is described with reference to FIG. 10, is described as dummy information, the communication, in which the transmission target data is embedded into the descriptors, is described as the dummy communication, and the communication, which is described with reference to FIG. 5, is described as the basic communication.

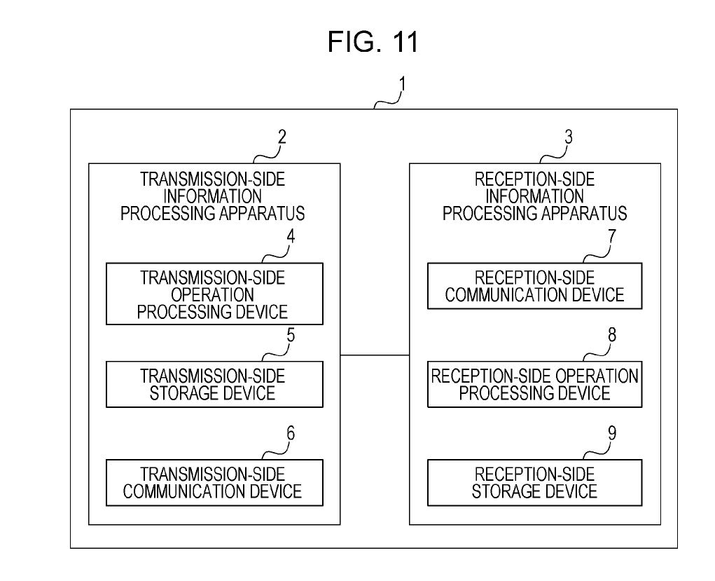

FIG. 11 illustrates an example of the configuration of an information processing system, according to an embodiment. In FIG. 11, the information processing system 1 includes a transmission-side information processing apparatus 2 and a reception-side information processing apparatus 3 which is connected to the transmission-side information processing apparatus 2 through a communication path.

The transmission-side information processing apparatus 2 includes a transmission-side operation processing device 4, a transmission-side storage device 5, and a transmission-side communication device 6. The transmission-side operation processing device 4 performs a transmission-side process (transmission process). The transmission-side storage device 5 includes a transmission-side storage area which holds target data (transmission target data) as a transmission target. The transmission-side communication device 6 transmits transmission data generated by the transmission-side process through the communication path, where the transmission data includes the control information (descriptor) including the target data and address information indicative of the address of the target data.

The reception-side information processing apparatus 3 includes a reception-side communication device 7, a reception-side operation processing device 8, and a reception-side storage device 9. The reception-side communication device 7 receives transmission data through the communication path. The reception-side operation processing device 8 performs a reception-side process (reception process). The reception-side storage device 9 includes a reception-side storage area which stores the target data that is extracted from the transmission data through the reception-side process.

Further, the transmission data includes payload information (communication data) in addition to the control information. The payload information may be null data or actual data.

Further, the control information includes communication mode information (communication type information), which indicates the communication mode between the transmission-side information processing apparatus 2 and the reception-side information processing apparatus 3, in addition to the address information. In addition, the transmission-side communication device 6 and the reception-side communication device 7 perform communication, based on a communication mode according to the communication mode information.

The transmission-side process generates the transmission data by dividing the target data into data segments and embedding the data segments into the control information.

Hereinafter, the process between the transmission-side information processing apparatus 2 and the reception-side information processing apparatus 3 will be described in detail. The transmission-side process (transmission process) and the reception-side process (reception process) perform communication using an inter-process data communication procedure. The inter-process data communication procedure is a procedure of the inter-process communication in which communication of the payload information (communication data) and the control information (descriptor) for controlling the communication of the payload information is performed between the transmission-side process and the reception-side process. In the inter-process data communication procedure, the payload information, which is received from the transmission-side process, is stored in a storage area (buffer) and the received respective pieces of control information are managed in order of reception in the reception-side information processing apparatus 3.

The transmission-side process performs communication with the reception-side process by using the inter-process data communication procedure. The transmission-side process transmits payload information and control information to the reception-side process by using the inter-process data communication procedure. In the embodiment, the payload information is dummy information. The control information is associated with the dummy information. In addition, the control information includes a first area (embedded area) in which data is rewritable, and a second area in which the information of the reception-side process is stored. The first area is different from the second area. The control information includes the first area which includes at least a part of the target data (transmission target data).

The reception-side process receives the dummy information and the control information from the transmission-side process, and takes at least a part of the target data out from the control information which is managed in order of reception.

Therefore, when a plurality of inter-process communication simultaneously occurs, it is possible to prevent the target data from being overwritten by communication data in another inter-process communication in the reception-side information processing apparatus 3. Therefore, it is possible to suppress occurrence of inter-process communications in order to prevent the target data from being overwritten, as described in, for example, the 2-2 method and the 2-3 method. In addition, it is possible to suppress communication for retransfer performed when data is overwritten, as described in, for example, the 2-1 method. In addition, it is possible to suppress a process of controlling retransfer, thereby preventing occurrence of backup or recovery for controlling retransfer.

In addition, in the embodiment, the target data is written in the first area which is used for storing information indicative of the size and stored location of data when the data is transmitted in the inter-process data communication procedure.

Therefore, it is possible to effectively cause the target data to be included in the control information and to transmit the target data from the transmission-side process to the reception-side process.

In addition, in the embodiment, the target data is written in the first area in which built-in data is stored in the inter-process data communication procedure.

Therefore, it is possible to effectively cause the target data to be included in the control information and to transmit the target data from the transmission-side process to the reception-side process.

In addition, the control information includes, in the first area, at least a part of the target data and the communication mode information (communication type information) indicative of the communication mode. The reception-side process takes at least a part of the target data out from the control information according to the communication mode indicated by the communication mode information included in the received control information.

Therefore, the reception-side process may identify whether or not the target data is included in the received control information.

In addition, the control information includes, in the second area, identification information identifying a transmission-side process. The transmission-side process divides the target data into plural data segments, and stores one or more data segments and the communication type information in the first area of each of plural pieces of control information. Further, the transmission-side process transmits the plural pieces of control information to the reception-side process. When the control information is received, the reception-side process extracts the data segments out from the first area according to the communication type information included in the first area, and reconstructs the target data by connecting the data segments which are extracted from the plural pieces of control information, according to the identification information included in the second area.

This allows the transmission-side process to transmit the target data by dividing the target data into plural pieces of control information. In addition, when the inter-process communication with a plurality of transmission-side processes simultaneously occurs in the reception-side information processing apparatus 3, the reception-side process is able to reconstruct the target data for a communication with each of the transmission-side processes, based on the plural pieces of control information.

In addition, in the reception-side information processing apparatus 3, an area, in which the dummy information is stored, is a fixed length buffer which is shared by the plurality of inter-process communications.

Therefore, when the plurality of inter-process communications occurs, it is possible to reduce the amount of buffer usage of the reception-side information processing apparatus 3.

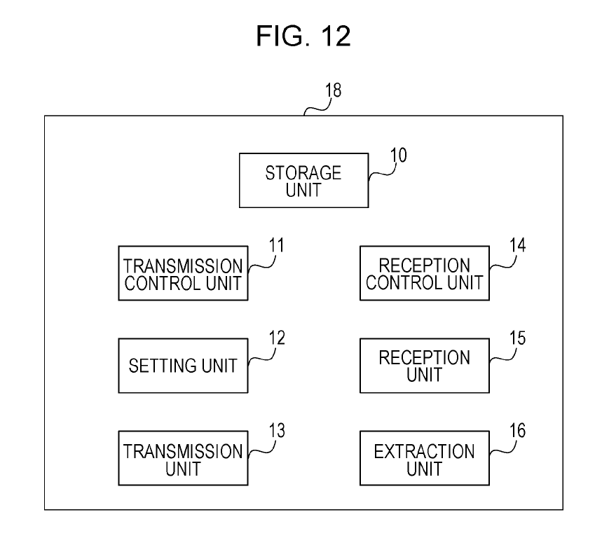

FIG. 12 illustrates an example of a configuration of a communication node, according to an embodiment. In FIG. 12, a communication node 18 includes a storage unit 10, a transmission control unit 11, a setting unit 12, a transmission unit 13, a reception control unit 14, a reception unit 15, and an extraction unit 16. The storage unit 10, the transmission control unit 11, the setting unit 12, and the transmission unit 13 are relevant to the data transmission. The storage unit 10, the reception control unit 14, the reception unit 15, and the extraction unit 16 are relevant to data reception.

The communication node 18 is an example of the transmission-side information processing apparatus 2 and the reception-side information processing apparatus 3. Some of the functions of the transmission control unit 11, the setting unit 12, and the transmission unit 13 are examples of the transmission-side process which is performed by the transmission-side operation processing device 4. In addition, a part of the function of the transmission unit 13 is an example of the transmission-side communication device 6. The reception control unit 14 and the extraction unit 16 are examples of the reception-side process which is performed by the reception-side operation processing device 8. The storage unit 10 is an example of the transmission-side storage device 5 in the transmission-side information processing apparatus 2. In addition, the storage unit 10 is an example of the reception-side storage device 9 in the reception-side information processing apparatus 3. The reception unit 15 is an example of the reception-side communication device 7.

In the storage unit 10, the MPI area, the application area, and a queue are secured. The queue is secured in, for example, an area such as kernel which is secured by the operating system (OS) of the communication node 18. In the MPI area, the area of the buffer, in which the received communication data is stored, is secured.

First, a data transmission process will be described.

The transmission control unit 11 selects a communication protocol to be used in the inter-process communication, according to the size of the transmission target data. More specifically, for example, the transmission control unit 11 first determines whether or not the size of the transmission target data is greater than a prescribed threshold. When the size of the transmission target data is less than the prescribed threshold, the transmission control unit 11 selects the Eager protocol as a protocol to be used when the transmission target data communication is performed. In contrast, when the size of the transmission target data is equal to or greater than the prescribed threshold, the transmission control unit 11 selects the Rendezvous-RDMA read protocol or the Rendezvous-RDMA write protocol as a protocol to be used when the transmission target data communication is performed. The prescribed threshold is stored in the storage unit 10 in advance. Also, the communication protocol, which is used in the transmission target data communication, may be designated by a user terminal. In addition, the transmission control unit 11 performs various processes according to the selected communication protocol.

In addition, the transmission control unit 11 generates communication data and a descriptor corresponding to the communication data. However, in the embodiment, the communication data is set at dummy data. The transmission control unit 11 sets communication control information for controlling the communication of the communication data (dummy data) to the descriptor. The dummy data is null data. The size of the dummy data may be a prescribed size, and it is possible to reduce the quantity of the communication or the quantity of buffer which is used for the communication by reducing the size of the dummy data.

The setting unit 12 embeds the transmission target data, which is originally desired to be communicated in the inter-process, into an area (hereinafter, referred to as an “embedded area”) of the descriptor, which becomes rewritable by setting the communication data as the dummy data. The embedded area is an area for storing rewritable data and is different from an area in which the information of the reception process is stored. Here, the setting unit 12 divides the transmission target data into a plurality of data segments and then embeds the resulting data segments into the embedded areas, according to the size of the transmission target data. The setting unit 12 performs division of the transmission target data so that each data segment has a size that allows the each data segment to be stored in the embedded area. Also, there is a case in which a single descriptor includes a plurality of embedded areas, and the respective sizes of the descriptor are different from each other. In this case, the setting unit 12 performs division by adjusting the sizes of the respective data segments so that the data segments are stored in the respective embedded areas. In addition, the setting unit 12 may store the communication type information, which is information indicative of whether or not the transmission target data is included in the descriptor, in the embedded areas. A process of storing the communication data in the descriptor will be described in detail later.

The transmission unit 13 transmits the communication data (dummy data) and the descriptor, into which the transmission target data (the data segments) is embedded, to the reception node.

Next, a data reception process will be described.

The reception control unit 14 secures a fixed length buffer in an MPI area in advance before data is received.

The reception unit 15 receives communication data (dummy data) and a descriptor from the transmission node. Thereafter, the reception unit 15 stores the communication data (dummy data) in the fixed length buffer. Here, the fixed length buffer, which stores the communication data, is a buffer which is commonly used for all the dummy communication. When the communication data (dummy data) is completely stored in the buffer, the reception unit 15 generates a reception completion notification based on the descriptor corresponding to the communication data (dummy data), and stores the reception completion notification in the queue.

The extraction unit 16 periodically performs polling, and determines whether or not the reception completion notification is stored in the queue. In monitoring though the polling, when it is recognized that the reception completion notification is stored in the queue, the extraction unit 16 determines whether or not the reception completion notification is generated in the dummy communication. More specifically, for example, the extraction unit 16 determines whether or not an area, into which the reception completion notification is embedded, includes the communication type information. When it is recognized that the reception completion notification includes the communication type information, the extraction unit 16 is able to realize that the reception completion notification is relevant to the dummy communication. When it is determined that the reception completion notification is generated in the dummy communication, the extraction unit 16 extracts the data segments, embedded into the embedded areas of the descriptor corresponding to the reception completion notification, from the reception completion notification. Further, the extraction unit 16 combines the extracted plurality of data segments.

The extraction unit 16 may determine whether communication corresponding to the reception completion notification is the basic communication or the dummy communication, based on information, which is included in the descriptor and which indicates the location of the buffer in which the communication data is stored. When the information, which indicates the location of the buffer in which the communication data is stored, indicates the fixed length buffer for the dummy communication, the extraction unit 16 may determine that communication corresponding to the reception completion notification is the dummy communication.

The combining of the data segments is performed based on a combining rule which is determined in advance. The combining rule is stored in the prescribed storage area of the storage unit 10. Also, it is assumed that the combining rule corresponds to a rule under which data segments, acquired through division performed on the transmission target data, are embedded into the descriptor in the transmission node. When a plurality of data segments corresponding to a single transmission target data are transmitted across a plurality of descriptors, the extraction unit 16 may combine the plurality of data segments, based on the order of reception of the reception completion notification. Also, for example, the transmission node may store prescribed information indicative of the end of the transmission target data at the last of the transmission target data, and the extraction unit 16 may realize the end of the transmission target data by recognizing whether the information indicative of the end is included in the data segments.

Further, the extraction unit 16 copies the reconstructed communication data onto the MPI area or the application area, according to the communication protocol. That is, when the communication protocol is the Eager protocol, the extraction unit 16 copies the transmission target data onto the application area. When the communication protocol is Rendezvous-RDMA read or Rendezvous-RDMA write, the extraction unit 16 copies the transmission target data (the information relevant to the communication control) onto the MPI area.

In addition, the reception control unit 14 and the reception unit 15 selects the communication protocol, according to the size of the transmission target data, or performs various processes, according to the selected communication protocol.

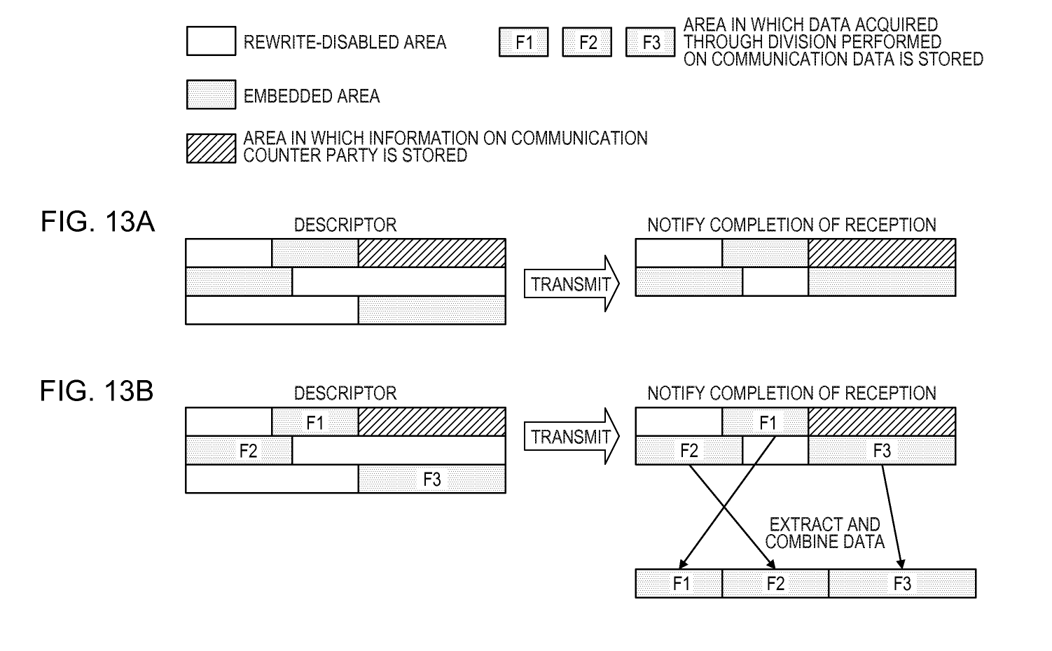

Next, embedment of the transmission target data into the descriptor by the setting unit 12 will be described. FIGS. 13A and 13B are diagrams illustrating the embedment of transmission target data into a descriptor by the setting unit 12.

FIG. 13A illustrates an example of the descriptor and the data structure of the reception completion notification in the basic communication. FIG. 13B illustrates an example of the descriptor and the data structure of the reception completion notification in the dummy communication.

As illustrated in FIG. 13A, the descriptor includes a plurality of areas (fields). The areas included in the descriptor are classified as areas (hereinafter, referred to as “rewrite-disabled areas”) in which it is not possible to rewrite data and areas (hereinafter, referred to as “rewritable area”) in which it is possible to rewrite data. In addition, communication counter party-relevant information is stored in some areas of the descriptor.

In the dummy communication, the transmission target data is stored in some of the embedded areas, which satisfy the three conditions below, in the areas of the descriptor, as shown in FIG. 13B.

(1) An area in which it is possible to rewrite data.

(2) An area in which information included in the reception completion notification is stored.

(3) The embedded areas, which are different from the areas in which the communication counter party-relevant information is stored, are areas which are determined in advance according to the specifications of the descriptor. Although the transmission target data is stored in some of the embedded areas, the transmission target data may be stored in the entire embedded area when the communication is not affected.

In the dummy communication, a reason that it is possible to embed the transmission target data into the embedded areas of the descriptor is that information originally stored in the embedded areas is information which is not used since the communication data is the dummy data. The information includes, for example, information indicative of the size of the communication data, information indicative of the location of a buffer for the communication data, or the like. When the communication data is the dummy data, actual communication is not affected even when the information is changed.

As illustrated in FIG. 13B, there is a case in which the descriptor includes a plurality of embedded areas. The transmission target data is divided into sizes, which allows the divided data segments to be stored in respective embedded areas, and embedded into the respective embedded areas.

The area, to which the transmission target data is embedded, is any one of areas in which information included in the reception completion notification is stored. Therefore, the transmission target data, which is embedded into the descriptor, is also included in the reception completion notification. The transmission target data, which is included in the reception completion notification, is extracted and combined by the extraction unit 16.

In FIG. 13B, the transmission target data is divided into “F1”, “F2”, and “F3”, embedded into the embedded areas of the descriptor, and then transferred. Further, in the reception node, “F1”, “F2”, and “F3”, which are acquired through division and which are embedded, are extracted from the reception completion notification and are combined.

There is a case in which the size of the transmission target data is greater than the sum of sizes of the embedded areas of a single descriptor. In this case, the transmission process divides the transmission target data, stores the resulting divided data segments in a plurality of descriptors, and then transmits the transmission target data to the reception node.

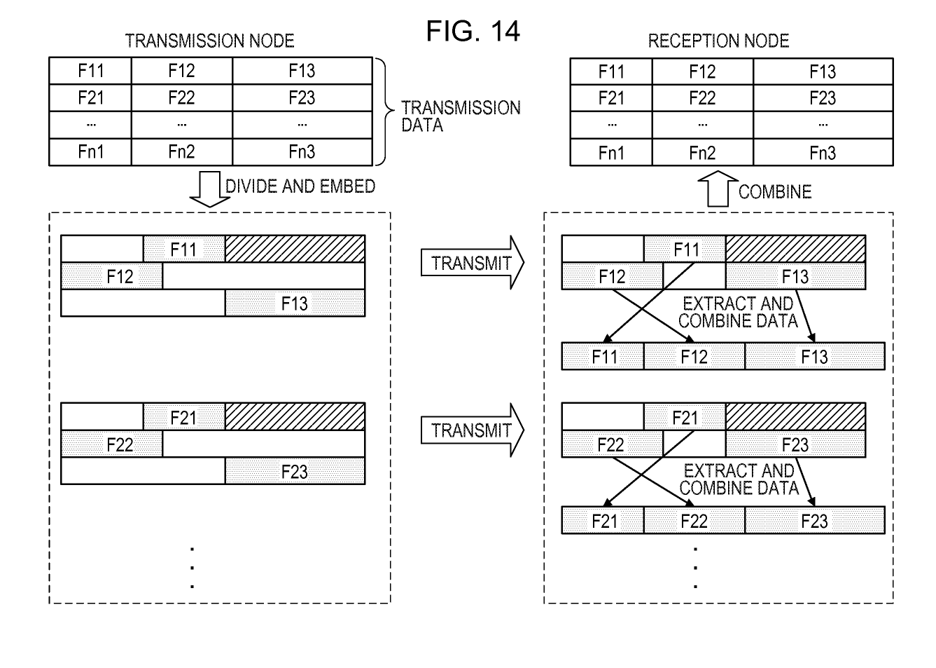

FIG. 14 is a diagram illustrating a state in which the transmission target data is transferred after being divided and embedded into a plurality of descriptors. In FIG. 14, the size of the transmission target data is greater than the sum of the sizes of the embedded areas of a single descriptor. In a case of FIG. 14, the transmission process divides the transmission target data, embeds data of “F11” to “F13” into a single descriptor, and transmits the data “F11” to “F13” to the reception node. Similarly, the transmission process embeds data of “Fx1” to “Fx3” (2≦x≦n)(n is an integer) into each single descriptor, and transmits the data of “Fx1” to “Fx3” to the reception node.

In addition, in FIG. 14, the extraction unit 16 extracts the transmission target data from embedded areas of each of the reception completion notifications respectively corresponding to the plurality of received descriptors, and connects the transmission target data. Further, the extraction unit 16 reconstructs original transmission target data by further combining the transmission target data which is extracted from the embedded areas of each reception completion notification.

Here, the extraction unit 16 is able to identify the communication counter party corresponding to the reception completion notification, with reference to information on the communication counter party, which is included in the reception completion notification. Accordingly, even when a plurality of inter-process communications simultaneously occurs, it is possible to extract, for each transmission process, transmission target data from the reception completion notifications and combine the data.

Next, the configuration of the descriptor will be described in detail. The descriptor is information which is used to control the communication of the inter-process of relevant communication data. The descriptor includes information on a communication method, a location on the memory of the communication counter party, in which the communication data is stored, the size of the communication data, the locational information of the communication counter party, and the like.

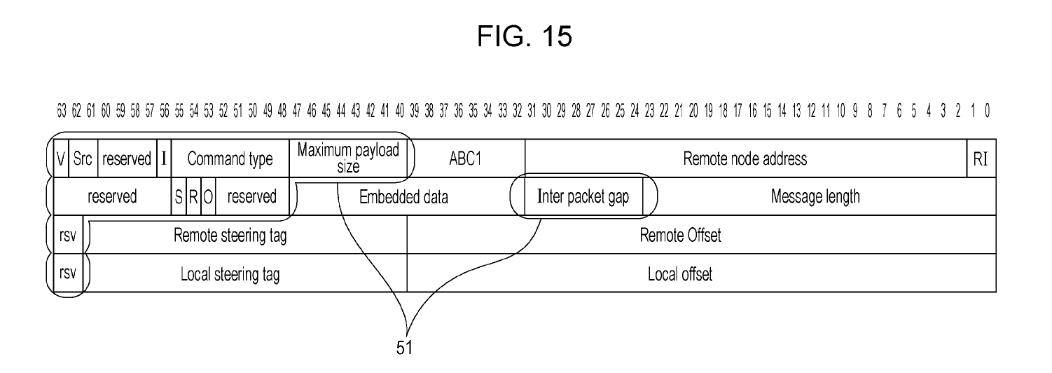

FIG. 15 illustrates an example of the data structure of the descriptor. In FIG. 15, information on the communication method is stored in an area 51. More specifically, information, such as a packet sending interval or a packet size, is stored in the area 51. The node coordinate information of a transfer destination of communication data is stored in areas “ABC1”, “Remote node address”, and “RI”. In an area “Embedded data”, built-in data is stored. The built-in data is data which is able to be freely rewritten by a user. In an area “Message length”, the size of the communication data is stored. In areas “Remote steering tag”, “local steering tag”, “Remote steering offset”, and “Local steering offset”, information indicative of the coordinates of an address space in which the communication data is transmitted and received. More specifically, in the area “Remote steering tag”, information indicative of the top address of a buffer in the node of the communication counter party, in which the communication data is stored, is stored. In addition, in the area “Local steering tag”, information indicative of the top address of a buffer in the node, in which the communication data is stored, is stored. In the area “Remote offset”, information, which indicates the address at which the communication data is stored in the node of the communication counter party and which is shown by the offset position from the address of the area “Remote steering tag”, is stored. In the area “Local offset”, information, which indicates the address at which the communication data is stored and which is shown by the offset position from the address of the area “Local steering tag”, is stored.

The reception completion notification is information which is generated by the reception unit 15 (communication module) based on the descriptor in the reception node. When the relevant communication data is completely stored in the buffer, the reception completion notification is stored in a queue by the reception unit 15. The extraction unit 16 periodically recognizes (performs polling) whether or not the reception completion notification is stored in the queue, and checks that the reception completion notification is stored in the queue. As a result, the extraction unit 16 is able to realize that the communication data is stored in the buffer, and to grasp the location in which the communication data is stored in the buffer.

More specifically, the reception completion notification includes the coordinate information of the node of the communication counter party. The coordinate information is information corresponding to information which is stored in the areas “ABC1”, “Remote node address”, and “RI” of FIG. 15. In addition, the reception completion notification includes the information of the built-in data. The information of the built-in data is information corresponding to the information which is stored in the area “Embedded data” of FIG. 15. In addition, the reception completion notification includes the information indicative of the size of the communication data. The information indicative of the size of the communication data is information corresponding to the information which is stored in the area “Message length” of FIG. 15. Further, the reception completion notification includes information of an address in which the data of the process reaches. The information of an address, which data of the process reaches, is information corresponding to the information which is stored in the area “Remote steering tag” or “Remote offset” of FIG. 15.

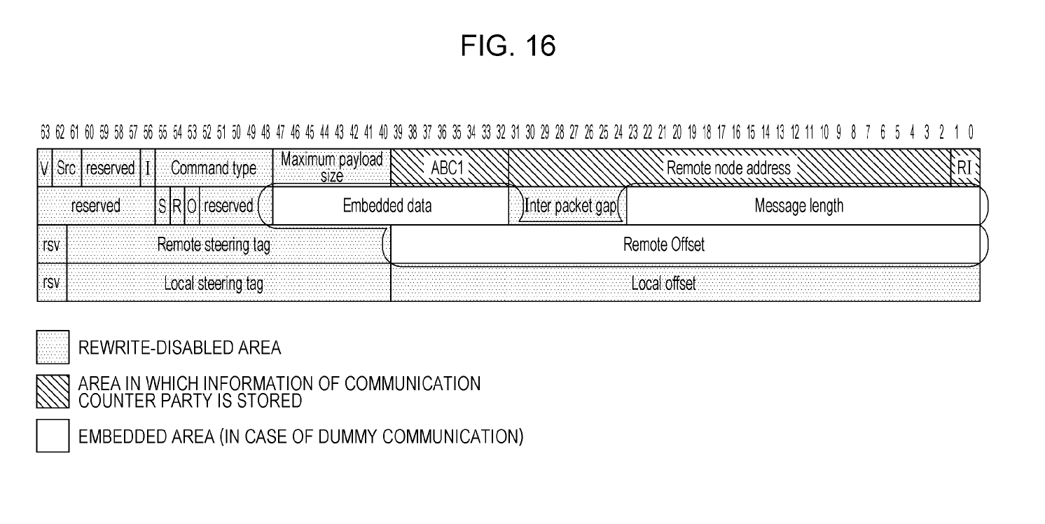

FIG. 16 illustrates an example of the embedded areas of the descriptor. The respective fields of the descriptor of FIG. 16 are classified as rewrite-disabled area, an area in which the information of the communication counter party is stored, and an embedded area.

The embedded area includes the areas “Embedded data”, “Message length”, and “Remote Offset”. The embedded area satisfies the above-described three conditions as the embedded area. Also, it is possible to change the size of the transmission target data, which is capable of being embedded into each of the embedded areas, by adjusting the size of the fixed length reception buffer which is used in the dummy communication. Also, an area, in which the information of the communication counter party is stored, includes areas “ABC1”, “Remote node address”, and “RI”, and includes the coordinate information of the node of the communication counter party. Also, when it is possible to use a plurality of queues, in which the reception completion notification is stored, it is possible to include the information on the transmission target data in the descriptor by associating a queue from which the reception completion notification is received with the bits of the transmission target data.

The communication type information, which is used for identifying whether the reception completion notification is generated in the basic communication or the dummy communication when the extraction unit 16 recognizes the reception completion notification which is stored in the queue, may be stored in the embedded area. More specifically, the communication type information may be stored in, for example, the area “Embedded data”. The communication type information may be information of 1 bit which indicates the basic communication or the dummy communication. In addition, the communication type information may further include protocol type information which indicates the type of a protocol used in a communication corresponding to the reception completion notification. The protocol type information may be information of 2 bits which indicates one of the communications according to the Eager protocol, the Rendezvous-RDMA read protocol, and the Rendezvous-RDMA write protocol.

The extraction unit 16 may identify whether the communication corresponding to the reception completion notification is the basic communication or the dummy communication, based on the value of the “steering tag”. That is, when a location indicated by the “steering tag” indicates the fixed length buffer for the dummy communication, the extraction unit 16 may determine that the communication corresponding to the reception completion notification is the dummy communication. This method enables the size of the transmission target data, which is capable of being stored in the embedded area, to increase, compared to a method in which the communication type information is embedded into the embedded area. This method is realizable because it is possible to fix a buffer, which is be used in a communication, to a prescribed address in advance in the dummy communication.

In the dummy communication, there is no possibility that the transmission target data disappears due to another data being overwritten on the transmission target data, even when a plurality of inter-process communications occurs in a single node. As described with reference to FIG. 7, overwriting is performed when the transmission target data are simultaneously stored in an overlapping reception buffer in two or more inter-process communications. In the dummy communication, dummy data is stored in the reception buffer, and the transmission target data is stored in the queue instead of the reception buffer in a state in which the transmission target data is embedded into the descriptors. Therefore, the communication data is not overwritten unlike FIG. 7.

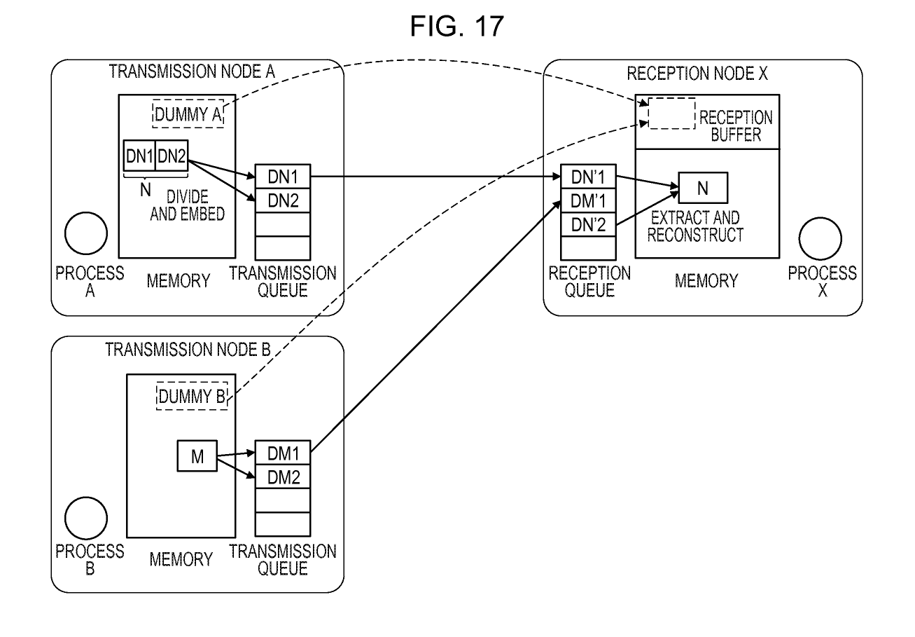

FIG. 17 is a diagram illustrating a state in which two transmission processes simultaneously transmit data to a single reception process in the dummy communication. In FIG. 17, the process A and the process B perform the dummy communication in order to simultaneously transmit transmission target data N and transmission target data M to the process X, respectively.

The process A (setting unit 12) divides the transmission target data N and embeds the divided transmission target data N into a plurality of descriptors (DN1 and DN2). Further, the process A (transmission unit 13) executes the dummy communication. Dummy data A and the descriptor DN1 are transmitted from the process A (transmission unit 13), and the dummy data A is stored in the reception buffer of the reception node X. Further, a reception completion notification DN′1 which is generated based on the descriptor DN1 is stored in a queue.

In the same manner, the process B (setting unit 12) divides the transmission target data M, and embeds the divided transmission target data M into a plurality of descriptors (DM1 and DM2). Further, the process B (transmission unit 13) executes the dummy communication. Dummy data B and the descriptor DM1 are transmitted from the process B (transmission unit 13), and the dummy data B is stored in the reception buffer of the reception node X. A reception completion notification DM′1 which is generated based on the descriptor DM1 is stored in the queue. Here, the reception buffer in which the dummy data B transmitted from the process B is stored, is the same as the reception buffer in which the dummy data A is stored. The dummy data B may be overwritten on the dummy data A. However, the communication is not affected because the dummy data is not referred to.

The process X (extraction unit 16) extracts the divided data of the transmission target data N and M from the respective reception completion notifications DN′1 and DM′1 which are stored in the queue. Further, the process X (extraction unit 16) extracts the divided data of the transmission target data N and M from the reception completion notifications DN′2 and DM′2 which are stored in the queue subsequent to the reception completion notifications DN′1 and DM′1. Further, the process X (extraction unit 16) acquires the transmission target data N and M by combining the extracted data for the respective processes (process A and process B). Here, the process X (extraction unit 16) is able to identify counter parties corresponding to the respective reception completion notifications with reference to information on the communication counter party included in the reception completion notifications.

The reception completion notifications are stored in the queue in the order in which the dummy data corresponding to the reception completion notifications are stored in the buffer. This allows the extraction unit 16 to control the combining of plural pieces of divided data included in the plurality of reception completion notifications, based on the order in which the reception completion notifications are stored. More specifically, for example, first, the setting unit 12 performs control so that the locations of the divided data in the transmission target data corresponds to the transmission orders of the descriptors into which the divided data are embedded. Further, the extraction unit 16 specifies the locations of the pieces of divided data, which are included in the reception completion notifications, within the transmission target data, from the order in which the reception completion notifications are stored in the queue. Further, the extraction unit 16 is able to correctly combine plural pieces of divided data by combining the plural pieces of divided data so that original transmission target data is obtained.

For example, in FIG. 17, DN1 and DN2 are two pieces of divided data in which DN1 is on a top side and DN2 is on an end side in the transmission target data N. Here, the process A (setting unit 12) performs control such that the transmission orders of the descriptors including DN1 and DN2 are the location orders (for example, the orders of the top addresses of the respective pieces of divided data) in the transmission target data. The process X (extraction unit 16) combines the pieces of divided data included in the respective reception completion notifications so as to correspond to the order in which the reception completion notifications are stored in the queue. In this case, the reception completion notifications are registered in the queue in the order of DN1 and DN2, and thus the process X (extraction unit 16) sets DN1 at the top and appends DN2 to the end of DN1. In this manner, the process X (extraction unit 16) is able to correctly reconstruct the transmission target data N.

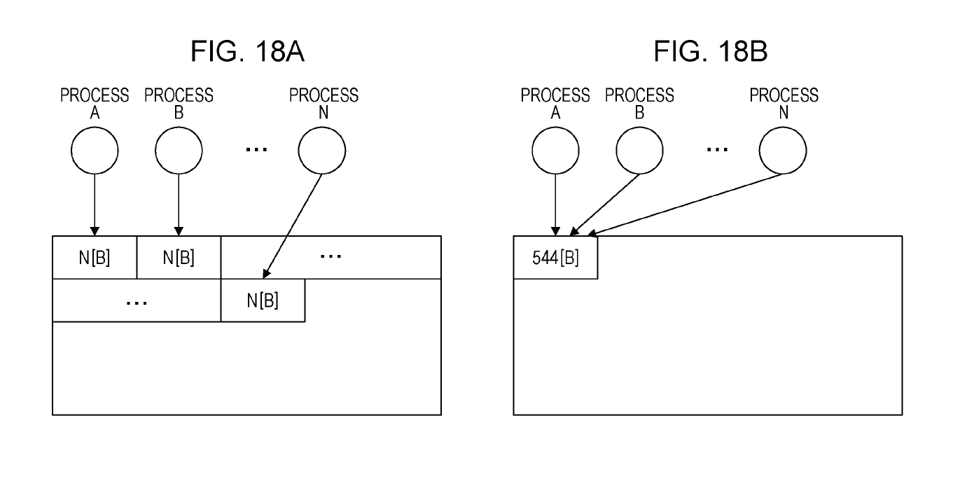

In the dummy communication, the buffer in which the dummy data is stored, is a fixed length buffer which is shared and used by a plurality of inter-process communications. FIGS. 18A and 18B are diagrams illustrating a method of securing buffers by comparing that of a first method in a basic communication with that of a dummy communication. FIG. 18A illustrates a state in which a buffer is secured in the first method. FIG. 18B illustrates a state in which a buffer is secured in the dummy communication.

Buffers corresponding to the processes of the respective communication counter parties (processes A to N in FIG. 18A) are secured in FIG. 18A. That is, buffers whose total size is N bytes x the number of processes are secured where N is the size of a buffer secured for each of the respective processes. In contrast, a single buffer, which is shared by all the processes of the communication counter parties, is secured in FIG. 18B. That is, a buffer of 544 bytes is secured.

In the dummy communication, data to be stored in the buffer is dummy data. Therefore, there is no problem even when the dummy data, which are stored by the plurality of processes, are overwritten. Accordingly, even when the number of processes of the communication counter parties increases, the communication is possible without increasing the amount of buffer usage. In the embodiment, the transmission target data is not overwritten, and thus it is possible to suppress the control communication which occurs to prevent the overwriting of the transmission target data. In the embodiment, it is possible to share and use a single fixed length buffer regardless of the number of processes of the communication counter parties, and thus it is possible to reduce the amount of buffer usage compared to the first method. The size of the fixed length buffer is 544 bytes in FIG. 18B. However, this is an example and the size of the fixed length buffer is not limited to the 544 bytes and may be set to a fixed value which does not depend on the number of processes.

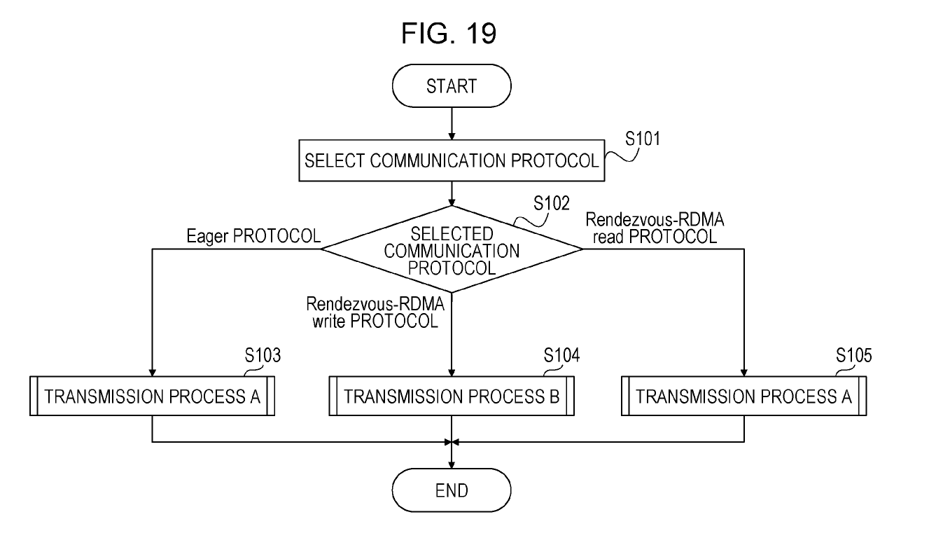

Next, an operational flowchart for the process of the transmission node according to the embodiment will be described. FIG. 19 is an example of an operational flowchart illustrating the process of the transmission node in the dummy communication according to the embodiment in detail.

In FIG. 19, first, the transmission control unit 11 of the transmission node selects a communication protocol (S101). That is, the transmission control unit 11 selects a communication protocol according to the size of transmission target data. When the communication protocol is selected, the transmission control unit 11 may notify the reception node of the selected protocol.

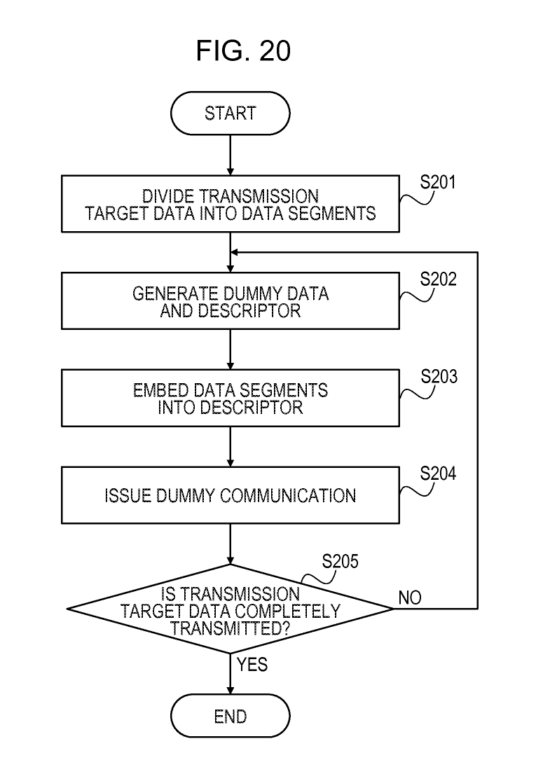

Subsequently, the transmission control unit 11 recognizes the selected communication protocol (S102). When it is determined that the selected communication protocol is the Eager protocol (Eager protocol in S102), the process proceeds to the transmission process A (S103). The transmission process A will be described in detail later with reference to FIG. 20. When the transmission process A is completed, the process ends.

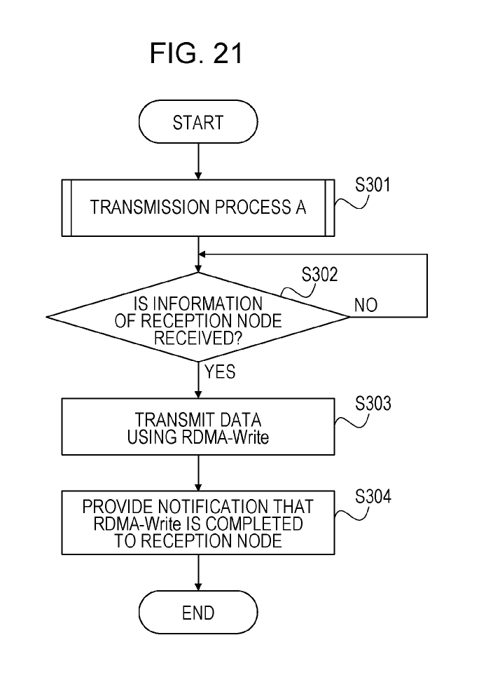

In S102, when it is determined that the selected communication protocol is the Rendezvous-RDMA write protocol (Rendezvous-RDMA write protocol in S102), the process proceeds to the transmission process B (S104). The transmission process B will be described in detail later with reference to FIG. 21. When the transmission process B is completed, the process ends.

In S102, when it is determined that the selected communication protocol is the Rendezvous-RDMA read protocol (Rendezvous-RDMA read protocol in S102), the process proceeds to the transmission process A (S105). The transmission process A will be described in detail later with reference to FIG. 20. In the embodiment, the transmission target data of the transmission process A which is executed in S105 is information on the communication control. When the transmission process A is completed, the process ends.

Subsequently, the transmission process A which is executed in S103, S105, and S301 (which will be described later), will be described. FIG. 20 is an example of an operational flowchart illustrating the details of the process of the transmission process A.

In FIG. 20, first, the setting unit 12 divides the transmission target data into plural pieces of divided data (data segments) according to the size of the transmission target data (S201). When the size of the transmission target data is a size of data storable in a single embedded area, the process in S201 may be omitted.

Subsequently, the transmission control unit 11 generates dummy data as communication data, and a descriptor corresponding to the communication data (S202). In S202, the transmission control unit 11 sets each of the areas of the generated descriptor at a setting value used when the communication data is transmitted to the reception node.

Subsequently, the setting unit 12 embeds the divided data into the embedded areas of the descriptor, which is generated in S202, (S203). In addition, the setting unit 12 may store communication type information in the embedded areas such that it is possible to determine whether a descriptor is used in the basic communication or the dummy communication.

Further, the transmission unit 13 issues the dummy communication (S204). That is, the transmission unit 13 transmits the communication data (dummy data), which is generated in S202, and the descriptor, to which the divided data (transmission target data) is embedded in S203, to the reception node.

Subsequently, the transmission control unit 11 determines whether or not the transfer of the transmission target data is completed (S205). That is, the transmission control unit 11 determines whether or not all the pieces of divided data, which are generated by dividing the transmission target data in S201, are embedded into the descriptors and transmitted. When it is determined that the transfer of the transmission target data is not completed (No in S205), the transmission control unit 11 causes the process to proceed to S202, and newly generates dummy data and a descriptor. In contrast, when it is determined that the transfer of the transmission target data is completed (Yes in S205), the process ends.

Subsequently, the transmission process B, which is executed in S103, will be described. FIG. 21 is an example of a flowchart illustrating the details of the process of the transmission process B.

In FIG. 21, first, the setting unit 12 executes the transmission process A (S301). The communication data of the transmission process A, which is executed in S301, is information on the communication control.

When the transfer of the information on the communication control is completed in S301, the transmission control unit 11 determines whether or not the information on the communication control of the reception node for RDMA transfer is received from the reception node (S302). When it is determined that the information on the communication control of the reception node is not received (No in S302), the transmission control unit 11 repeats the process in S302.

In S302, when it is determined that the information on the communication control of the reception node is received (Yes in S302), the transmission control unit 11 transfers the transmission target data according to RDMA-Write (S303). That is, the transmission control unit 11 designates the address of the application area of the reception node, which is the storage destination of the transmission target data, based on the information on the communication control of the reception node which is received in S302, and transmits the transmission target data. As a result, the transmission control unit 11 writes the transmission target data in the designated application area of the reception node.

Further, the transmission control unit 11 transmits the notification that the communication of RDMA-Write is completed to the reception control unit 14 (S304). Thereafter, the process ends.

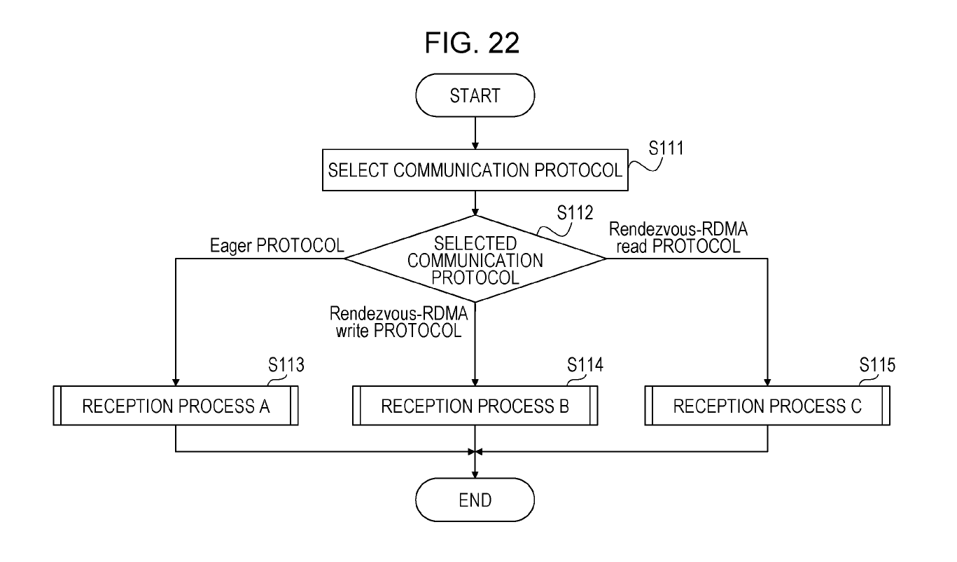

Next, an operational flowchart for the process of the reception node according to the embodiment will be described. FIG. 22 is an example of a flowchart illustrating the details of the process in the dummy communication performed by the reception node according to the embodiment.

In FIG. 22, first, the reception control unit 14 of the reception node selects a communication protocol (S111). That is, the reception control unit 14 selects a communication protocol according to the size of the transmission target data. When the communication protocol is selected, the reception control unit 14 may notify the transmission node of the selected protocol.

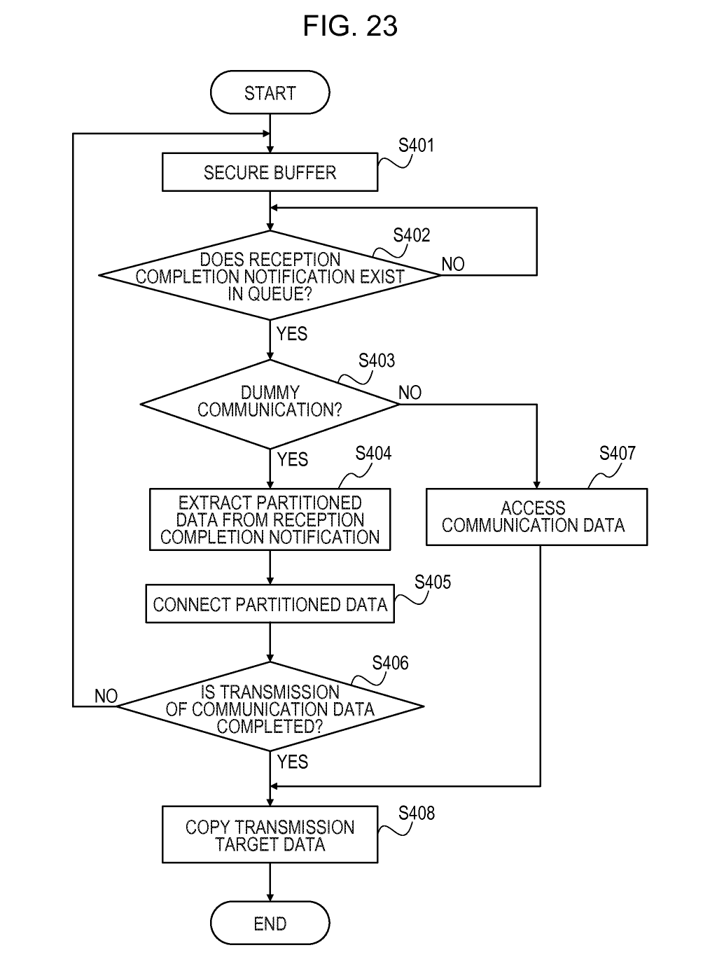

Subsequently, the reception control unit 14 recognizes the selected communication protocol (S112). When it is determined that the selected communication protocol is Eager protocol (Eager protocol in S112), the process proceeds to the reception process A (S113). The details of the reception process A will be described later with reference to FIG. 23. When the reception process A is completed, the process ends.

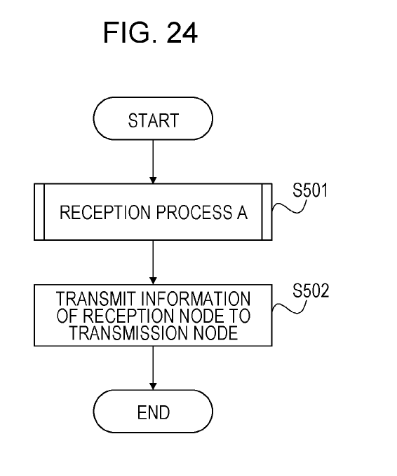

When it is determined that the selected communication protocol is the Rendezvous-RDMA write protocol in S112 (Rendezvous-RDMA write protocol in S112), the process proceeds to the reception process B (S114). The details of the reception process B will be described later with reference to FIG. 24. When the reception process B is completed, the process ends.

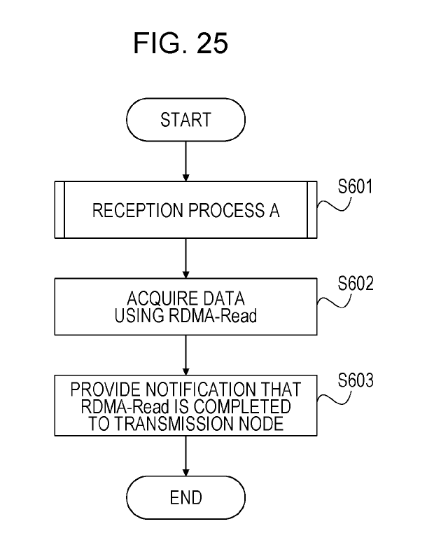

When it is determined that the selected communication protocol is Rendezvous-RDMA read protocol in S112 (Rendezvous-RDMA read protocol in S112), the process proceeds to the reception process C (S115). The details of the reception process C will be described later with reference to FIG. 25. When the reception process C is completed, the process ends.

Subsequently, the reception process A which is executed in S113 will be described. FIG. 23 is an example of an operational flowchart illustrating the details of the process of the reception process A.

In FIG. 23, first, the reception control unit 14 secures a fixed length buffer in an MPI area (S401). Here, the secured fixed length buffer is shared and used by all the dummy communications.

Subsequently the, extraction unit 16 determines whether or not a reception completion notification is stored in a queue (S402). When it is determined that the reception completion notification is not stored in the queue (No in S402), the extraction unit 16 executes the process in S402 again.

In contrast, when it is determined that the reception completion notification is stored in the queue (Yes in S402), the extraction unit 16 takes the reception completion notification out from the top of the queue, and determines whether or not the reception completion notification is generated in the dummy communication (S403). More specifically, the extraction unit 16 determines whether or not the communication type information is included in the reception completion notification. In addition, the extraction unit 16 determines whether or not information, which is included in the reception completion notification and which indicates the top address of a buffer in which the communication data is stored, indicates the fixed length buffer for the dummy communication.

When it is determined that the reception completion notification is generated in the dummy communication (Yes in S403), the extraction unit 16 extracts pieces of divided data (transmission target data) from the reception completion notification (S404).

Further, the extraction unit 16 combines the pieces of divided data which are extracted in S404 (S405). That is, the extraction unit 16 combines the plural pieces of transmission target data (the plural data segments), which are extracted in S404, based on a combining rule, which is determined in advance, and the order in which the reception completion notifications are received. Also, the extraction unit 16 identifies a transmission source process corresponding to the reception completion notification with reference to information on communication counter party included in the reception completion notification. Then, for each of the identified communication source processes, the extraction unit 16 extracts pieces of data from the reception completion notification and combines the extracted pieces of data.

Subsequently, the reception control unit 14 determines whether or not the transfer of the communication data is completed (S406). That is, the reception control unit 14 determines whether or not information indicative of the end of the transmission target data is included in the divided data which are extracted in S404. When it is determined that the transfer of the communication data is not completed (No in S406), the reception control unit 14 causes the process proceeds to S401. When it is determined that the transfer of the communication data is completed (Yes in S406), the reception control unit 14 causes the process proceeds to S408.

In S403, when it is determined that the reception completion notification is not generated in the dummy communication (No in S403), the reception control unit 14 specifies the location (address) of a buffer, in which the communication data is stored, from the reception completion notification, and accesses the specified location (S407). Thereafter, the process proceeds to S408.

In S408, the reception control unit 14 copies the reconstructed transmission target data into the MPI area or the application area according to the communication protocol. Thereafter, the process ends.

Next, the reception process B, which is executed in S114, will be described. FIG. 24 is an example of an operational flowchart illustrating the details of the process of the reception process B.

In FIG. 24, first, the reception process A is executed (S501). In the reception process A, which is executed in S501, the transmission target data in S408 is copied into the MPI area.

Subsequently, the reception control unit 14 transmits information on the communication control of the reception node to the transmission node (S502). Thereafter, the transmission target data is transferred by the transmission node according to the RDMA-Write, based on the information on the communication control. Thereafter, the process ends.

Next, the reception process C, which is executed in S115, will be described. FIG. 25 is an example of an operational flowchart illustrating the details of the process of the reception process C.

In FIG. 25, first, the reception process A is executed (S601). In the reception process A, which is executed in S601, the transmission target data in S408 is copied into the MPI area.

Subsequently, the reception control unit 14 acquires the transmission target data according to the RDMA-Read, based on the information on the communication control of the transmission node, which is copied into the MPI area in S408 (S602).

Then, the reception control unit 14 transmits the notification that the communication is completed according to the RDMA-Read, to the transmission control unit 11 (S603). Thereafter, the process ends.

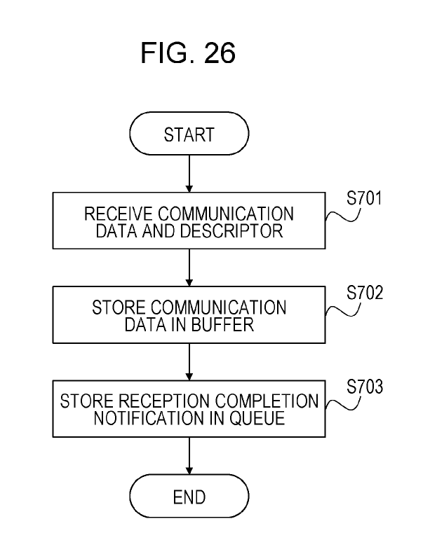

Subsequently, an operational flowchart for a data reception process performed by the reception unit 15 according to the embodiment will be described. FIG. 26 is an example of an operational flowchart illustrating the details of the data reception process performed by reception unit 15 according to the embodiment.

In FIG. 26, reception unit 15 first receives the communication data and the descriptor corresponding to the communication data, from the transmission node (S701). Subsequently, the reception unit 15 stores the relevant communication data in the buffer, based on the descriptor (S702). Further, the reception unit 15 generates a reception completion notification based on the descriptor, and stores the generated reception completion notification in a queue (S703). Thereafter, the process ends.

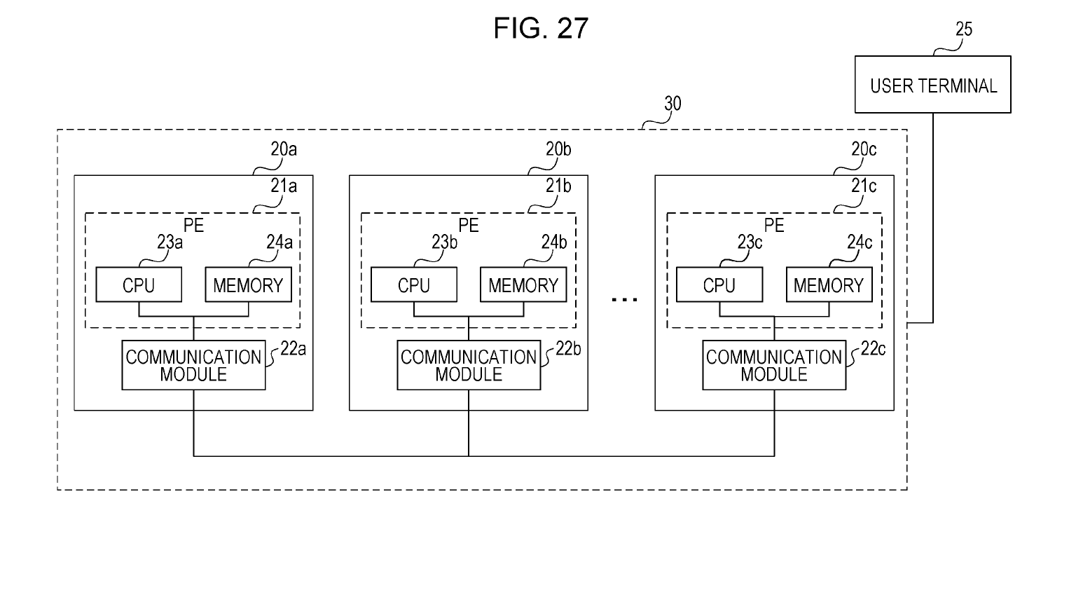

Subsequently, the configuration of an information processing system according to the embodiment will be described. FIG. 27 illustrates an example of a hardware configuration of an information processing system according to an embodiment.

In FIG. 27, the information processing system 30 includes one or more information processing apparatuses 20 (20a, 20b, and 20c). Each of the information processing apparatuses 20 includes one or more PEs 21(21a, 21b, and 21c), and a communication module 22 (22a, 22b, or 22c) which is connected to each PE 21. The PE 21 includes a CPU 23 (23a, 23b, or 23c) and a memory 24 (24a, 24b, or 24c). The CPU 23, the memory 24, and the communication module 22 are connected to each other through a bus or the like. Respective communication modules 22 are connected through an interconnect. In addition, the respective communication modules 22 may be connected to a storage device (not shown in the drawing), which stores information, through an interconnect, a communication network, or the like. The information processing system 30 is connected to a user terminal 25, through, for example, a network such as a LAN. The information processing system 30 is an example of the information processing system 1. The information processing apparatus 20 is an example of the communication node 18.

The CPU 23 provides some or the entirety of the functions of the transmission control unit 11, the setting unit 12, the transmission unit 13, the reception control unit 14, and the extraction unit 16, by executing, using the memory 24, a program in which the procedure of the above-described flowchart is written. That is, the CPU 23 provides some or the entirety of the functions of the transmission-side operation processing device 4 in the transmission-side information processing apparatus 2, by executing, using the memory 24, the program in which the procedure of the above-described flowchart is written. The CPU 23 provides some or the entirety of the functions of the reception-side operation processing device 8 in the reception-side information processing apparatus 3, by executing, using the memory 24, the program in which the procedure of the above-described flowchart is written.

The memory 24 is, for example, a semiconductor memory, and includes a random access memory (RAM) area and a read only memory (ROM) area. The memory 24 provides some or the entirety of the functions of the storage unit 10. That is, the memory 24 provides some or the entirety of the functions of the transmission-side storage device 5 in the transmission-side information processing apparatus 2. In addition, the memory 24 provides some or the entirety of the functions of the reception-side storage device 9 in the reception-side information processing apparatus 3.

The communication module 22 is a module which performs communication through a network or an interconnect, according to the instruction of the CPU 23. The communication module 22 provides some or the entirety of the functions of the transmission unit 13 and the reception unit 15. That is, the communication module 22 provides some or the entirety of the functions of the transmission-side communication device 6 in the transmission-side information processing apparatus 2. In addition, the memory 24 provides some or the entirety of the functions of the reception-side communication device 7 in the reception-side information processing apparatus 3.

The information processing apparatus 20 may include a reading device. The reading device accesses a detachable storage medium, according to the instruction of the CPU 23. The detachable storage medium is realized by, for example, a semiconductor disk (USB memory or the like), a medium (magnetic disc or the like) to which information is input by a magnetic action, a medium (a CD-ROM, a DVD, or the like) to which information is input by an optical action, or the like.

A program according to the embodiment is provided to the CPU 23, for example, in the form below

(1) installed in the memory 24 in advance.

(2) provided using a detachable storage medium (not shown in the drawing).

(3) provided from a program server (not shown in the drawing) through the communication module 22.

A part of the information processing apparatus 20 may be realized by hardware. Further, the information processing apparatus 20 may be realized by the combination of software and hardware.

The user terminal 25 transmits a program execution instruction to the information processing system 30, and receives a program execution result as a response. The program execution instruction is transmitted to one or more PEs 21 which are included in the information processing system 30. In execution of a single program, a plurality of processes is executed, and data communication is performed through inter-process. Each of the processes is executed in one or more PEs 21. In inter-process communication, an MPI is used. Each of the processes which performs the inter-process communication may switch between protocols (Eager and Rendezvous-RDMA), which are used in the inter-process communication, according to, for example, the amount of transfer data for communication data.

Also, in the embodiment, an area, in which the reception completion notification is stored, is a queue. However, the area is not limited to the queue if the area is controlled such that the reception completion notification corresponding to the communication data is sequentially stored in the order in which the reception node receives the communication data, and a reception sequence is secured. In addition, the dummy communication may be performed through two inter-processes which are executed in the same communication node 18.

Also, the embodiment is not limited to the above-described embodiment, and various configurations or embodiments can be provided without departing from the gist of the embodiment.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An information processing system comprising:
a transmission-side apparatus including:
a first processor configured to execute a transmission-side process on target data to be transmitted to a reception-side apparatus through a communication path, the transmission-side process generating transmission data including payload information and control information, the control information including the target data and address information indicating a destination address of the target data,
a first memory including a transmission-side storage area for holding the target data, and
a first communication module configured to transmit the transmission data through the communication path; and
the reception-side apparatus coupled to the transmission-side apparatus through the communication path, the reception-side apparatus including:
a second memory including a queue area configured to store pieces of information as queueing data so as to prevent a piece of information from being overwritten by another piece of information,
a second communication module configured to receive the transmission data transmitted from the transmission-side apparatus through the communication path,
a second processor configured to execute a reception-side process on the received transmission data, wherein
the transmission-side process controls transmission of the transmission data to the reception-side apparatus through the communication path by embedding the target data into the control information included in the transmission data; and
the reception-side apparatus stores the control information in the received transmission data into the queue area as queuing data, and extracts the embedded target data from the control information stored in the queue area.

2. The information processing system of claim 1, wherein
a predetermined data that is not used for both the transmission-side process and the reception-side process is set as the payload information.

3. The information processing system of claim 1, wherein
an actual data that is used for the transmission-side process or the reception-side process is set as the payload information.

4. The information processing system of claim 1, wherein
the control information further includes communication mode information indicating a communication mode between the transmission-side apparatus and the reception-side apparatus; and
the first communication module and the second communication module perform transmission of the transmission data, according to the communication mode indicated by the communication mode information.

5. The information processing system of claim 1, wherein
the transmission-side process generates plural pieces of transmission data by:
dividing the target data into plural data segments, and
embedding each of the plural data segments into the control information of different one of the plural pieces of transmission data.

6. An apparatus coupled to another apparatus through a communication path, the apparatus comprising:
a memory including a storage area for holding target data to be transmitted to the another apparatus through the communication path;
a processor configured to execute a process including
generating transmission data including payload information and control information, the control information including the target data and address information indicating a destination address of the target data;
a communication module configured to transmit the transmission data to the another apparatus through the communication path, wherein
the process controls transmission of the transmission data to the another apparatus through the communication path by embedding the target data into the control information included in the transmission data, so as to cause the another apparatus:
to store the control information included in the received transmission data into a queue area, the queue area being configured to store pieces of information as queueing data so as to prevent a piece of the information from being overwritten by another piece of the information, and
to extract the embedded target data from the control information stored in the queue area.

7. A method for controlling an information processing system including a transmission-side apparatus, and a reception-side apparatus that is coupled to the transmission-side apparatus through a communication path, the method comprising:
providing the reception-side apparatus with a queue area configured to store pieces of information as queueing data so as to prevent a piece of the information from being overwritten by another piece of the information;
executing, by the transmission-side apparatus, a transmission-side process on target data to be transmitted to the reception-side apparatus through the communication path, the transmission-side process generating transmission data to be transmitted to the reception-side apparatus through the communication path, the transmission data including payload information and control information, the control information including the target data and address information indicating a destination address of the target data;
transmitting, by the transmission-side apparatus, the transmission data to the reception-side apparatus through the communication path;
receiving, by the reception-side apparatus, the transmission data transmitted from the transmission-side apparatus through the communication path;
executing, by the reception-side apparatus, a reception-side process, wherein
the transmission-side process controls transmission of the transmission data to the reception-side apparatus through the communication path by embedding the target data into the control information included in the transmission data; and
the reception-side process stores the control information in the received transmission data into the queue area as queuing data, and extracts the embedded target data from the control information stored in the queue area.

8. A non-transitory, computer-readable recording medium having stored therein a program for causing a computer included in an information processing apparatus to execute a process, the information processing apparatus being coupled to another information processing apparatus through a communication path, the process comprising:
generating transmission data including payload information and control information, the control information including target data that is to be transmitted to the another apparatus through the communication path and address information indicating a destination address of the target data; and
controlling transmission of the transmission data to the another apparatus through the communication path by embedding the target data into the control information included in the transmission data, so as to cause the another information processing apparatus:
to store the control information included in the received transmission data into a queue area, the queue area being configured to store pieces of information as queueing data so as to prevent a piece of the information from being overwritten by another piece of the information, and
to extract the embedded target data from the control information stored in the queue area.
